(19) United States
(12) Patent Application Publication
(10) Pub. No.: US 2018/0325314 A1
(43) Pub. Date: Nov. 15, 2018

(54) GRILLS HAVING FLAVORIZING MATERIAL CONTAINERS

(71) Applicant: Phase 2, LLC, St. Louis, MO (US)

(72) Inventor: Jon Scott Walters, St. Louis, MO (US)

(21) Appl. No.: 15/975,287

(22) Filed: May 9, 2018

Related U.S. Application Data
(60) Provisional application No. 62/503,743, filed on May 9, 2017.

(51) Int. Cl. A47J 37/07; A23B 4/052

(52) U.S. Cl. CPC A47J 37/0786; A23V 2002/00; A47J 37/0704; A23B 4/0526

(57) ABSTRACT

A grill assembly is disclosed which includes a grate having an upper surface configured to support an item of food to be cooked, a cooking chamber, a gas burner or a pellet burner, and a container. The gas burner or pellet burner is adapted to be installed within the cooking chamber and below the grate and to operate using a gaseous fuel or a pellet fuel. The container includes an interior wall, a floor, and an exterior wall adapted to be positioned within the chamber, below the grate, and with the interior wall adjacent the gas burner or the pellet burner. At least one of the interior wall, the floor and the exterior wall of the container defines an opening for allowing a hot gas from the gas or pellet burner to pass into the container. The container can be adapted to hold charcoal and/or wood. The cooking chamber may be formed from an earthen material and can be adapted to support the grate within the cooking chamber.

### CROSS REFERENCE TO RELATED APPLICATIONS

This application claims the benefit of U.S. Provisional Patent Application Ser. No. 62/503,743 filed on May 9, 2017. The entire contents of the above application is hereby incorporated by reference.

### FIELD OF THE INVENTION

Grill assemblies are provided which can burn pellets, gas or charcoal as the fuel source. The grill assembly can include a pellet burner that can be easily removed and replaced with a propane gas burner or with a conventional charcoal or wood burning unit and ash tray if an alternative fuel source is preferred. Charcoal or wood may be burned in a container within the grill assembly to alter the flavor of the food. Liquid flavorizers may also be used.

### BACKGROUND OF THE INVENTION

Heavy ceramic grills and the like have burned charcoal and wood for the fuel source. Lighter metal grills have burned pellets for the fuel source. None of these grills provide the features or benefits of the present invention.

### BRIEF SUMMARY OF THE INVENTION

In an aspect, a grill assembly is provided which includes a grate having an upper surface configured to support an item of food to be cooked, a cooking chamber, a gas burner or a pellet burner, and a container. The gas burner or pellet burner is adapted to be installed within the cooking chamber and below the grate and to operate using a gaseous fuel or a pellet fuel. The container includes an interior wall, a floor, and an exterior wall adapted to be positioned within the chamber, below the grate, and with the interior wall adjacent the gas burner or the pellet burner. At least one of the interior wall, the floor and the exterior wall of the container defines an opening for allowing a hot gas from the gas or pellet burner to pass into the container. The container can be adapted to hold charcoal and/or wood.

The cooking chamber can be formed from an earthen material and adapted to support the grate within the cooking chamber. The cooking chamber can be formed from metal.

The gas burner of the grill assembly can be adapted to operate using the gaseous fuel, or the pellet burner of the grill assembly can be adapted to operate using the pellet fuel.

The grill assembly can include a fire bowl adapted to be positioned inside the cooking chamber. The container can be adapted to be suspended from the fire bowl or adapted to rest on and be supported by a surface of the fire bowl.

The grill assembly can include a heat spreader adapted to be positioned over the gas or pellet burner.

The grill assembly can include a water pan adapted to be positioned above the gas burner or the pellet burner and below the grate. The water pan can be further adapted to be positioned above the container. For example, the water pan can be further adapted to be positioned on top of and supported by the container, and thereby adapted to cover the top of the container.

The water pan can include a lid adapted to be removably fastened to the water pan. The lid can define an opening to allow the water pan to be refilled without removing the lid. The lid can include a transparent portion, whereby a water level in the pan is visible while the lid is fastened to the water pan.

The grill assembly can include a handle for lifting the water pan and/or a bracket for suspending the water pan from a fire bowl inside the cooking chamber.

The grill assembly can include a second container sized to fit within the container, the second container being adapted to hold a liquid.

The grill assembly can further include a removable chassis adapted to mount the gas burner or the pellet burner; and a fire bowl adapted to be positioned within the cooking chamber and including an opening extending between an interior of the fire bowl and an exterior of the fire bowl. The chamber can include an opening for receiving the removable chassis and positioning the gas or pellet burner below the fire bowl.

When the grill assembly includes the removable chassis, the cooking chamber can include an upper shell and a lower shell. The opening for receiving the removable chassis can be in the lower shell. The grill assembly can further include an attachment interface coupled to the lower shell adjacent the opening in the lower shell, the attachment interface configured to receive the removable chassis when the removable chassis is inserted in the opening in the lower shell.

When the grill assembly includes the removable chassis, the cooking chamber can include an upper shell and a lower shell. The opening for receiving the removable chassis can be in the lower shell. The lower shell can include a protrusion defining the opening in the lower shell for receiving the removable chassis.

The container can comprise metal or an earthen material, and preferably comprises metal.

The opening in the container can further include an opening in the interior wall, and/or an opening in the floor and/or an opening in the exterior wall. For example, the opening in the container can further include an opening in the interior wall and an opening in the exterior wall.

The opening in the exterior wall can be located near the top of the exterior wall. Alternatively, the opening in the exterior wall can be located adjacent or below a midpoint of the exterior wall, the midpoint being a position about one half of a distance up the exterior wall measured from the floor.

The opening in the interior wall can be located adjacent the floor.

The container can include a plurality of openings in the interior wall and/or a plurality of openings in the exterior wall for allowing a hot gas from the gas burner or the pellet burner to pass into the container.

The container can include an adjustable cover to selectively cover one or more of the plurality of openings in the interior wall and/or the plurality of openings in the exterior wall for controlling burning of the charcoal or wood within the container.

The container can further include a removable lid spanning the interior wall and the exterior wall. The lid can define an opening for enabling smoke generated inside the container to exit the container.

The container can have various shapes, such as an arcuate shape. The container can be configured as a hollow cylinder wherein the interior wall is an inner cylinder, the exterior wall is an outer cylinder, the floor is a base circle adjoining the inner and outer cylinders, and the volume of the hollow cylinder is adapted to hold the charcoal or the wood. The interior wall and the exterior wall of the container can have a cross-sectional view that defines a pair of substantially concentric circles.

A height of the exterior wall of the container can be at least twice a width of the floor.

The container can be adapted to be positioned adjacent the heat spreader. For example, the container can include an arcuate shape adapted to be positioned adjacent the heat spreader. In other instances, the container can include a circular shape adapted to be positioned around the heat spreader with the interior wall adjacent the heat spreader.

When the container is configured as the hollow cylinder, the heat spreader can have a cylindrical shape, and the interior wall of the container can be adapted to be positioned around the heat spreader such that the heat spreader is adapted to fit within a hollow center of the hollow cylinder.

In accordance with another aspect, there is provided a container adapted to be used with a grill assembly. The grill assembly includes a grate having an upper surface configured to support an item of food to be cooked, a cooking chamber, and a gas burner or pellet burner adapted to be installed within the cooking chamber and below the grate and to operate using a gaseous fuel or a pellet fuel. The container includes an interior wall, a floor, and an exterior wall. The container is adapted to be positioned within the chamber, below the grate, and with the interior wall adjacent the gas burner or the pellet burner. At least one of the interior wall, the floor and the exterior wall of the container defines an opening for allowing a hot gas from the gas or pellet burner to pass into the container. The container is configured to hold charcoal and/or wood.

The container can include the features as described above for the container of the grill assembly.

Other objects and features will be in part apparent and in part pointed out hereinafter.

### BRIEF DESCRIPTION OF THE SEVERAL VIEWS OF THE DRAWINGS

The drawings described herein are for illustrative purposes only of selected embodiments and not all possible implementations, and are not intended to limit the scope of the present disclosure.

FIG. 1 is a cross sectional side view of a kamado-style grill including a unit extending through a chamber opening and a heat spreader removably coupled to the unit according to one example embodiment of the present disclosure.

FIG. 2 is a perspective view of a removable unit and a heat spreader including perforations.

FIG. 3 is a perspective view of the heat spreader of FIG. 2.

FIG. 4 is a perspective view of a conical shaped heat spreader.

FIG. 5 is a perspective view of a rectangular shaped heat spreader.

FIG. 6 is a cross sectional side view of a kamado-style grill including a support bracket for supporting a structure.

FIG. 7 is a top view of the support bracket of FIG. 6.

FIG. 8 is a top view of a support bracket including two nonintersecting cross beams.

FIG. 9 is a perspective view of the support bracket of FIG. 6 supporting a structure.

FIG. 10 is a cross sectional side view of a kamado-style grill including the heat spreader of FIG. 1 and the support bracket of FIG. 6.

FIG. 11 is a top perspective view of a removable unit including a gas port system and an ignition system.

FIG. 12 is a top perspective view of the removable unit of FIG. 11 with its cover removed.

FIG. 13 is a top perspective view of a removable unit including an open flame burner.

FIG. 14 is a top perspective view of a removable unit including an ash receptacle, vents and a slidable vent cover.

FIG. 15 is a perspective view of a removable unit including an ash receptacle and rotatable vent covers.

FIG. 16 is a front view of a kamado-style grill including a vent cover and a vent lock for locking the vent.

FIG. 17 is a zoomed in front perspective view of a vent cover and a vent lock including a removable pin.

FIG. 18 is a perspective view of a support frame of a kamado-style grill and a removable unit sleeve coupled to the support frame.

FIG. 19 is a front view of the support frame and sleeve of FIG. 18, where the sleeve is storing a removable gas unit.

FIG. 20 is a front view of the support frame and sleeve of FIG. 18, where the sleeve is storing a removable charcoal unit.

FIG. 21 is a perspective top view of a support frame and a gas source cart coupled to the support frame.

FIG. 22 is a perspective top view of the support frame and the cart of FIG. 21 with a gas source coupled to the cart.

FIG. 23 shows an assembled grill that is fueled by pellets.

FIG. 24 shows the assembly of some components of a grill that is fueled by pellets.

FIG. 25 shows a close up view of some of the component parts of a pellet feeder for the use of pellets as a fuel source.

FIG. 26 shows a top view of a pellet feeder with the lid to the pellet box in the open position.

FIG. 27 shows a view of the control panel and display for setting a desired temperature for a grill and for connecting sensors to the controller.

FIG. 28 shows a pellet feeder with an extension box to provide additional capacity for holding more pellets.

FIG. 29 shows a pellet feeder without an extension box.

FIG. 30 shows an extension box which can be used to increase the capacity of a pellet feeder to hold more pellets.

FIG. 31 shows a pellet feeder adapted to have a pellet box beneath a shelf.

FIG. 32 is a top partial view of a kamado-style grill having a flavorizing material container according to one example embodiment of the present disclosure.

FIG. 33 is a top view of a flavorizing material container including a receptacle and a handle according to another example embodiment.

FIG. 34 is a top partial view of a kamado-style grill having two of the containers of FIG. 33 disposed in the grill, according to yet another example embodiment.

FIG. 35 is a top view of two of the flavorizing material containers of FIG. 33 according to another example embodiment.

FIG. 36 is a partial cross-sectional side view of a kamado-style grill having a fire bowl and two flavorizing material containers disposed in the fire bowl according to yet another example embodiment.

FIG. 37 is a partial cross-sectional side view of a kamado-style grill having a fire bowl, a flavorizing material container disposed in the fire bowl, and a water pan resting on top of the container according to yet another example embodiment.

FIG. 38 is a partial cross-sectional side view of a kamado-style grill having a fire bowl and a flavorizing material container suspended from the fire bowl according to yet another example embodiment.

FIG. 39 shows a side view of a curved sheet of metal formed as a side wall of a flavorizing material container.

FIG. 40 shows a lid for a flavorizing material container.

FIG. 41 shows a water pan and bracket for suspending the water pan from the upper edge of a fire bowl.

FIG. 42 shows a cover for a water pan.

FIG. 43 shows a second container for holding a liquid and sized to fit within a flavorizing material container.

Corresponding reference characters indicate corresponding parts and/or features throughout the drawings.

### DETAILED DESCRIPTION OF THE INVENTION

Exemplary embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

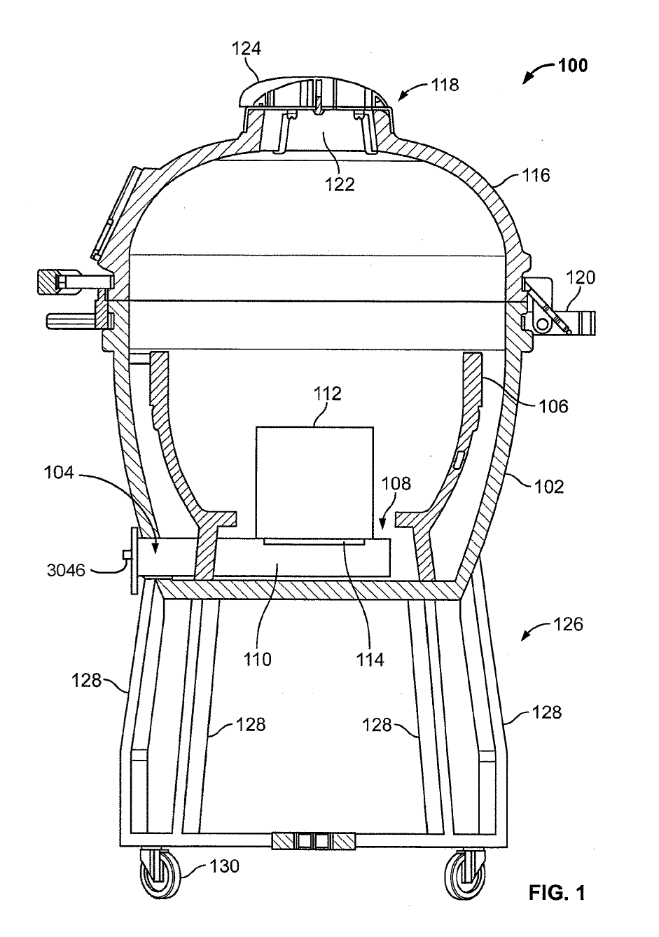

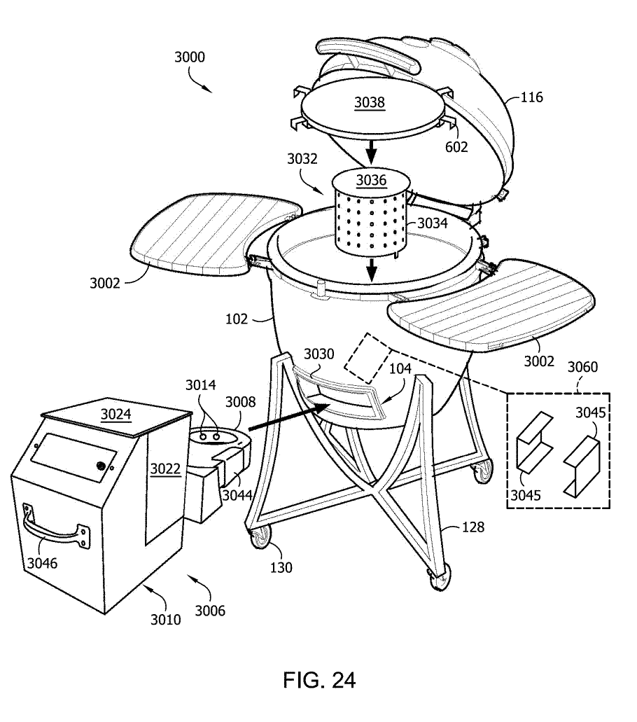

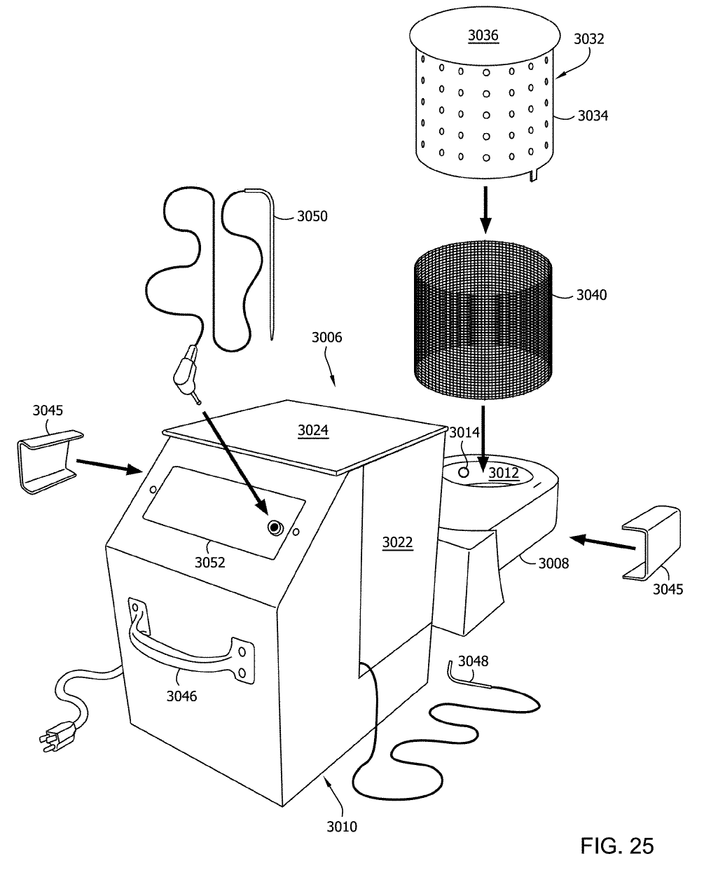

A kamado-style grill assembly according to one aspect of the present disclosure is illustrated in FIG. 1 and indicated generally by reference number 100. As shown in FIG. 1, the kamado-style grill assembly 100 (sometimes referred to herein as the grill 100, the kamado-style grill 100, etc.) includes a lower shell or vessel 102 defining an opening 104 extending between an interior of the lower shell 102 and an exterior of the lower shell 102, a fire bowl 106 removably positioned within the lower shell 102 and defining an opening 108 extending between an interior of the fire bowl 106 and an exterior of the fire bowl 106, a unit 110 extending through the opening 104 of the lower shell 102 for positioning below the opening 108 of the fire bowl 106, and a heat spreader 112 removably coupled to the unit 110. The unit 110 (sometimes referred to as a gas unit 110) includes a gas burner 114 configured to radiate heat into the fire bowl 106. As seen, the heat spreaders 112/212 are of the same design and construction as the metal heat exchanger 3032 shown in FIGS. 24 and 25, and these terms are used interchangeably herein.

The heat spreader 112 is formed at least partially of a thermally conductive material to absorb heat radiated from the gas burner 114 of the gas unit 110 and spread heat away from the gas burner. Thus, the heat spreader 112 and/or the other heat spreaders disclosed herein transfer heat from one area (e.g., adjacent the burner 114) to another area. As such, the heat spreader 112 and/or the other heat spreaders disclosed herein may be considered heat exchangers.

The heat spreader 112 may allow heat to spread throughout the kamado-style grill 100. For example, if the heat spreader 112 is employed as in FIG. 1, heat normally concentrated substantially above the gas burner 114 can be spread via the heat spreader 112 to areas near the perimeter of the fire bowl 106. This allows for a more uniform temperature (and in some cases a uniform temperature) throughout the grill, including a cooking surface of the grill, compared to other grills not including a heat spreader. As such, users may experience better cooking results when using the kamado-style grill 100.

The thermally conductive material may include, for example, one or more metallic materials such as iron, aluminum, copper, steel, etc. and/or alloys thereof. The thermally conductive material can include stainless steel such as 304 stainless steel, etc. Additionally and/or alternatively, the thermally conductive material may include other suitable materials such as ceramic materials, carbon based materials, etc.

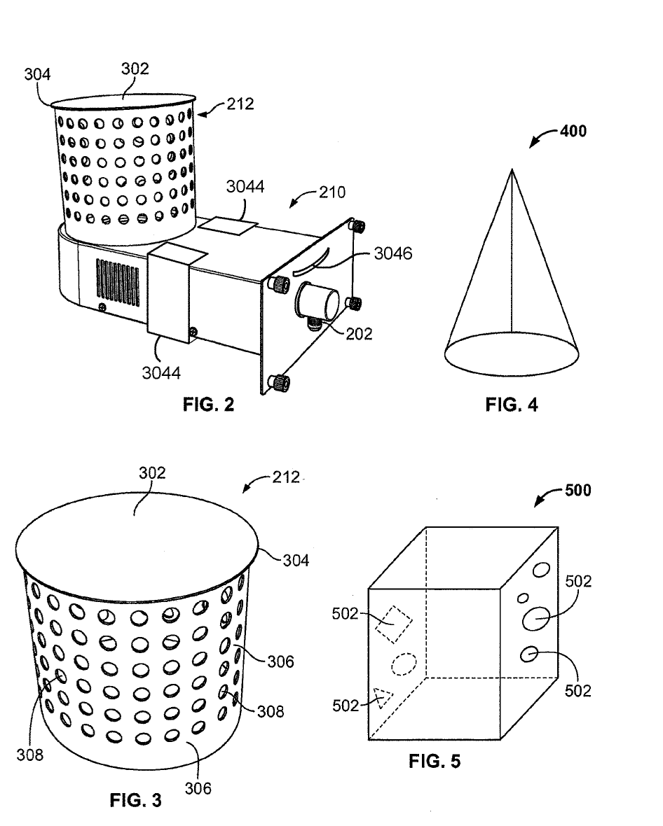

As explained above, the heat spreader 112 is removably coupled to the gas unit 110. For example, and as shown in FIGS. 1 and 2, the heat spreader 112 can rest on top of the gas unit 110. The heat spreader 112 can be removably coupled to the gas unit 110 via one or more mechanical fasteners (e.g., screws, clamps, bolts, nuts, etc.), adhesives, etc.

Preferably, and as shown in FIG. 1, the heat spreader 112 substantially aligns with the gas burner 114 when the heat spreader 112 is coupled to the gas unit 110. This allows the heat spreader 112 to substantially shield the gas burner 114 from undesirable materials such as objects falling from above the gas unit 110 (e.g., grease, dirt, etc.). As such, the heat spreader 112 may protect the gas burner 114 from the undesirable materials that may otherwise disrupt and sometimes damage the gas burner. The heat spreader 112 may be offset from the gas burner 114 when the heat spreader 112 is coupled to the gas unit 110. For example, the heat spreader 112 may overlay about half the gas burner 114 or another suitable amount if desired.

The unit 110 may be attached to the grill 100 if desired. For example, the unit 110 may be coupled to the fire bowl 106, the vessel 102 and/or another component of the grill via one or more mechanical fasteners, adhesives, etc.

The unit 110 may be a removable unit. For example, the removable unit 110 may be one of various different units insertable through the opening 104 of the vessel 102. In such examples, the opening 104 of the vessel 102 may be configured to receive another removable unit when the removable gas unit 110 is removed from the vessel 102. As such, the kamado-style grill 100 can operate as a gas fired grill when the removable gas unit 110 is inserted in the opening 104 of the vessel 102 and a charcoal fired grill, for example, when another removable unit is inserted in the opening 104 of the vessel 102.

For example, a user can remove a removable charcoal unit from the vessel opening 104 (if previously installed) and insert (e.g. slide, etc.) the removable gas unit 110 in the vessel opening 104 such that the gas burner 114 is positioned substantially below the fire bowl opening 108. After which, the user can place the heat spreader 112 on top of the gas burner 114 via the fire bowl opening 108, and optionally attach the heat spreader 112 to the removable gas unit 110 (e.g., with clamps, adhesives, etc.), as explained above.

FIGS. 2 and 3 illustrate an example heat spreader 212 and/or an example removable gas unit 210, each of which may be employed in the kamado-style grill 100 of FIG. 1 and/or another suitable grill such as those disclosed herein. As shown in FIG. 2, the removable gas unit 210 includes an input 202 (sometimes called an input gas port) for receiving flammable gas as further explained below.

The heat spreader 212 of FIGS. 2 and 3 includes a top surface 302 defining a perimeter 304 and a side surface 306 extending from the top surface 302. The top surface 302 includes a solid surface. This allows the top surface 302 of the heat spreader 212 to shield a gas burner of the unit 210 and/or another suitable unit (e.g., the unit 110 of FIG. 1) from undesirable materials, as explained above.

As shown best in FIG. 3, the side surface 306 extends from the top surface 302 on an interior side of the perimeter 304. Put another way, the top surface 302 extends beyond an edge of the side surface 306. This arrangement between the top surface 302 and the side surface 306 helps shield the gas burner from undesirable materials as explained above. Alternatively, the side surface 306 may extend from the top surface 302 at the perimeter 304 if desired.

As shown in FIGS. 2 and 3, the side surface 306 may define one or more perforations 308 to allow air to flow through the heat spreader 212. By allowing air to flow through the heat spreader, heat may spread throughout a grill (e.g., the kamado-style grill 100 of FIG. 1 and/or another suitable grill) more efficiently than with other employable heat spreaders without perforations (as further explained below).

The perforations 308 may be uniformly positioned about the heat spreader 212 as shown in FIGS. 2 and 3, or alternatively randomly positioned if desired. The perforations 308 may be circular shaped (as in FIGS. 2 and 3) and/or another suitable shape such as triangular, oval, rectangular, etc. Additionally, although the perforations 308 are uniform in size, it should be understood that the heat spreader 212 may include various sized perforations.

As shown best in FIG. 3, the heat spreader 212 is substantially cylindrical. This allows the heat spreader 212 to substantially align with a substantially circular gas burner (not shown) without wasting heat spreader material. Alternatively, the heat spreader 212 may have another suitable shape. In such cases, the shape (e.g., the cross sectional shape) of a particular heat spreader may be similar as or different than the shape (e.g., the cross sectional shape) of its corresponding gas burner.

For example, FIGS. 4 and 5 illustrate example heat spreaders 400, 500, respectively, that may be employed in the kamado-style grill 100 and/or another suitable grill. As shown, the heat spreader 400 of FIG. 4 is shaped as a cone and the heat spreader 500 of FIG. 5 is shaped as a cube. As such, the cross sectional shape of the heat spreader 400 has a similar shape as the cross sectional shape of a circular gas burner whereas the cross sectional shape of the heat spreader 500 has a different shape.

As shown in FIG. 5, the heat spreader 500 includes various sized and shaped perforations 502 on two of its opposing side surfaces to allow air to flow through the heat spreader 500. In particular, one of the side surfaces defines three perforations 502 (e.g., a triangular perforation, a rectangular perforation, and an oval perforation) while the other side surface defines four perforations 502 (e.g., oval perforations). Alternatively, other side surfaces (including adjacent side surfaces) of the heat spreader 500 may define the perforations 502. A heat spreader may not define perforations. For example, the heat spreader 400 of FIG. 4 does not include perforations.

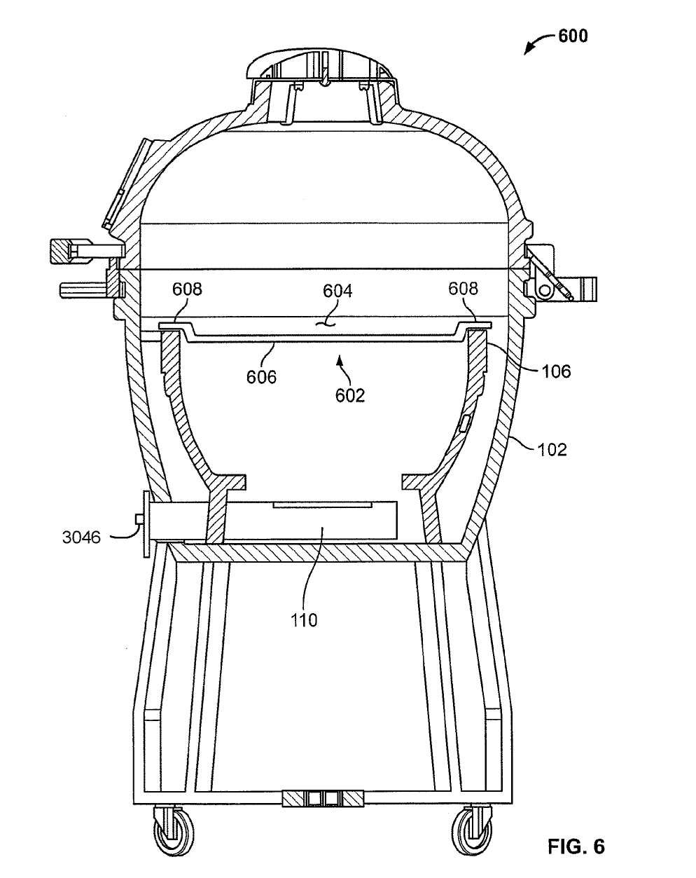

FIG. 6 illustrates another example kamado-style grill 600 substantially similar to the grill 100 of FIG. 1, but including a support bracket instead of a heat spreader. In particular, the kamado-style grill 600 includes the vessel 102, the fire bowl 106, and the unit 110 of FIG. 1, and a support bracket 602 removably coupled to the fire bowl 106. As shown in FIG. 6, the support bracket 602 extends across at least a portion of an opening 604 of the fire bowl 106 for supporting a structure (not shown).

As shown in FIG. 6, the support bracket 602 includes a transverse portion 606 and leg portions 608 on opposing ends of the transverse portion 606. In the particular example of FIG. 6, the leg portions 608 rest on a top surface of the fire bowl 106 and extend downwardly into an interior portion the fire bowl 106 through the opening 604. The transverse portion 606 extends across the opening 604 of the fire bowl 106. Put another way, the leg portions 608 are configured to allow the transverse portion 606 to extend across the opening 604 and below the top surface of the fire bowl 106. Thus, the support bracket 602 is removably coupled to the fire bowl 106 such that the support bracket 602 is positioned substantially within the fire bowl 106.

Alternatively, the leg portions 608 of the support bracket 602 may not extend downwardly into the fire bowl 106. In such examples, the transverse portion 606 extends across the opening 604 at or above the top surface of the fire bowl 106.

Additionally, the support bracket 602 may be removably coupled to the fire bowl 106 via one or more fasteners. For example, the leg portions 608 may be removably coupled to the fire bowl 106 with one or more clamps, brackets, and/or other suitable fasteners if desired.

Preferably, the support bracket 602 is removably coupled to the fire bowl 106 after the gas unit 110 and the heat spreader 112 are installed as explained above. After which, a structure (e.g., a lava stone, etc.) may be placed on the support bracket 602 as further explained below. Alternatively, the support bracket 602 may be removably coupled to the fire bowl 106 before the gas unit 110 and/or the heat spreader 112 are installed if desired.

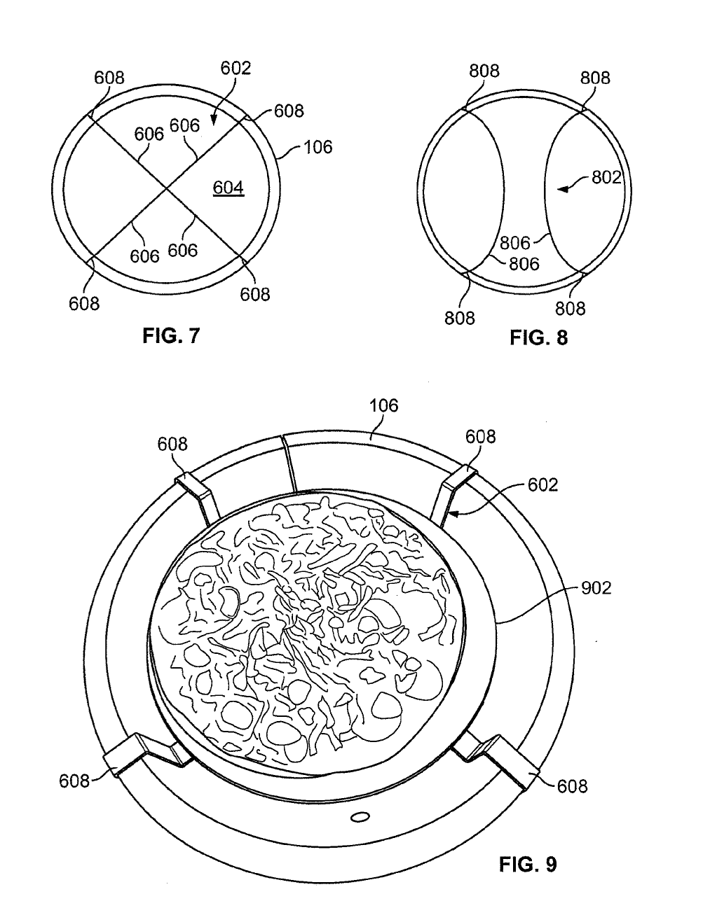

In the particular example of FIG. 6, the support bracket 602 includes a substantially “X” shape. For example, and as shown in FIG. 7, the support bracket 602 includes four leg portions 608 and two transverse portions (e.g., cross beams, etc.) 606 extending across the opening 604 of the fire bowl 106. The transverse portions 606 intersect each other adjacent the opening 604 of the fire bowl 106 to form the substantially “X” shaped support bracket 602.

Alternatively, other suitable shaped support brackets may be utilized in the kamado-style grill 600 and/or other grills disclosed herein. For example, a support bracket may include a star shaped support bracket, a triangular shaped support bracket, a rectangular shaped support bracket, etc. FIG. 8 illustrates another example support bracket 802 employable in the kamado-style grill 600 and/or other grills disclosed herein. As shown in FIG. 8, the support bracket 802 includes two transverse portions 806 and four leg portions 808 on opposing ends of the transverse portion 806. Similar to the support bracket 602 of FIGS. 6 and 7, the support bracket 802 may be removably coupled to the fire bowl 106 by resting on the top surface of a fire bowl and/or via one or more fasteners as explained above.

In the particular example of FIG. 8, each transverse portion 806 extends in an arc between its corresponding leg portions 808. This allows the transverse portions 806 to extend near a center portion of the opening 604 of the fire bowl 106 without intersecting each other. Thus, the support bracket 802 of FIG. 8 includes a shape resembling seams on a baseball (e.g., a substantially “II” shape).

Additionally, although FIG. 6 illustrates the kamado-style grill 600 as including the gas unit 110, it should be apparent that other suitable units may be employed without departing from the scope of the disclosure. For example, the grill 600 may include a charcoal related unit, a removable charcoal related unit, a removable gas unit, etc. instead of the gas unit 110

As explained above, the support bracket (e.g., the support bracket 602 of FIGS. 6 and 7, the support bracket 802 of FIG. 8, and/or another suitable support bracket) supports a structure (e.g., a cooking surface, etc.). For example, FIG. 9 illustrates a structure 902 removably coupled to the support bracket 602 of FIGS. 6 and 7. In particular, the structure 902 rests on the transverse portions (not shown) of the support bracket 602 and the leg portions 608 of the support bracket 602 rest on the top surface of the fire bowl 106 as explained above.

The structure 902 can then be used, for example, as a cooking surface to cook desired items (e.g., a pizza as shown in FIG. 9, etc.). Additionally and/or alternatively, the structure 902 can spread heat across an opening of the kamado-style grill 600 and/or other grills disclosed herein. For example, food may be placed on a grate and/or another suitable cooking surface above the structure 902, directly on the structure 902 (e.g., as shown in FIG. 9), etc. In such examples, the structure 902 can spread heat across its surface and the grill's opening so that the food is evenly cooked.

In other examples, the structure 902 may vaporize liquids. For example, when a user cooks food with one of the grills disclosed herein, liquid from that food may drip onto the structure 902. This liquid that contacts the structure 902 may be vaporized (e.g., due to the temperature of the structure 902, etc.) and mix with the smoke within the grill. This causes the food, which is at least partially cooked by the smoke, to have enhanced flavors. Thus, the structure 902 may be used at least as a cooking surface, a heat spreader, and/or a vaporization device.

In the particular example of FIG. 9, the structure 902 includes a lava stone. The lava stone may be formed of natural volcanic rock and/or other suitable materials. Alternatively, other suitable structures may be removably coupled to the support bracket 602 and/or other the support brackets disclosed herein. For example, the structure may include a grate (e.g., a steel grate, etc.), a solid plate (e.g., a metallic plate, etc.), wood (e.g., cedar, etc.), other stones, etc.

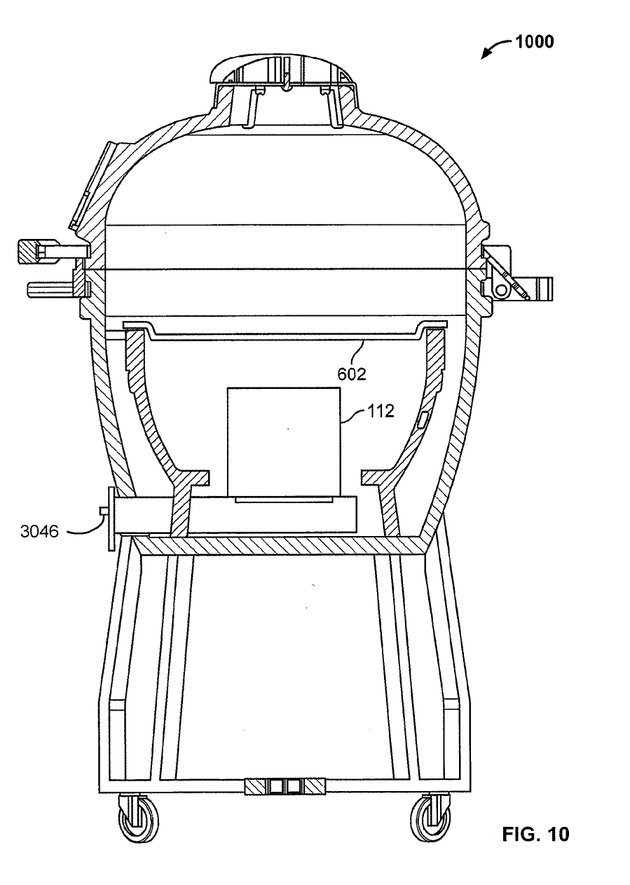

The grills disclosed herein may include a heat spreader and a support bracket. For example, FIG. 10 illustrates a kamado-style grill 1000 substantially similar to the grill 100 of FIG. 1 but including the support bracket 602 of FIGS. 6 and 7 in combination with the heat spreader 112 of FIG. 1. Additionally and/or alternatively, other suitable support brackets and/or heat spreaders may be employed in the grill 1000 of FIG. 10 if desired.

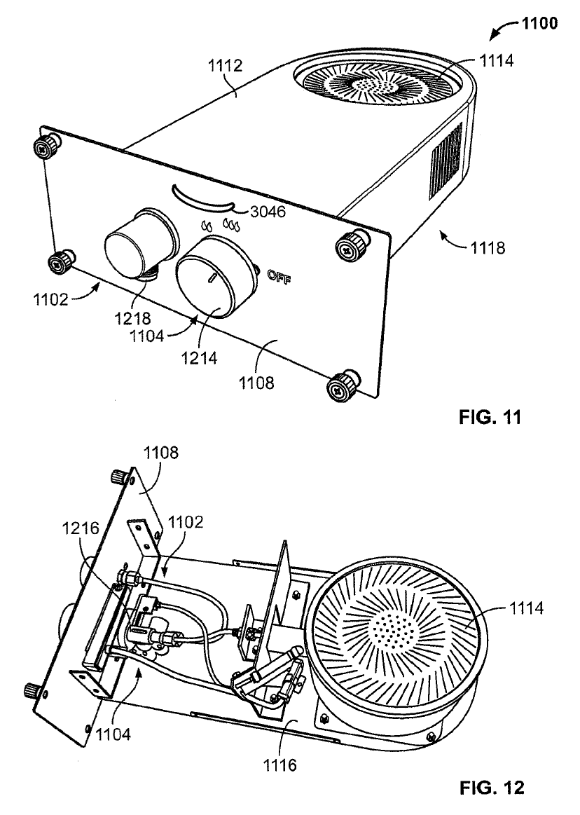

The gas units (including the removable gas units, etc.) disclosed herein may include various optional components. For example, FIGS. 11 and 12 illustrate a removable gas unit 1100 including a gas burner 1114, a gas port system 1102 for receiving flammable gas, an ignition system 1104, and a housing 1118 for housing various components (e.g., conduits, etc.) of the gas burner 1114 and the systems 1102, 1104.

The housing 1118 includes a faceplate 1108, a base support 1116 removably coupled to the faceplate 1108, and a cover 1112 removably coupled to the faceplate 1108 and/or the base support 1116. As shown in FIG. 11, portions of the gas port system 1102 and the ignition system 1104 are positioned on an exterior facing side of the faceplate 1108. In particular, inputs such as gas inputs, user inputs, etc. of the systems 1102, 1104 are the positioned on the exterior side of the faceplate 1108.

As shown in FIG. 11, the ignition system 1104 includes a controller 1214 including one or more user inputs to ignite the gas burner 1114, adjust an amount of flammable gas received by the gas burner, etc. For example, a user may manipulate (e.g., push, rotate, etc.) the controller 1214 to generate a spark to ignite the flammable gas. The controller 1214 may include, for example, one or more igniters such as electronic igniters which may or may not include batteries, piezo igniters, etc. that can generate the spark to ignite the flammable gas. In the particular example of FIGS. 11 and 12, the controller 1214 includes a piezo igniter.

The controller 1214 of FIGS. 11 and 12 can also be used to adjust an amount of flammable gas received by the gas burner 1114. For example, a user can manipulate (e.g., push, rotate, etc.) the controller 1214 such that the amount of flammable gas from the gas port system 1102 is controlled. In the particular example of FIGS. 11 and 12, the controller 1214 is rotated to control the amount of flammable gas. The different amounts of flammable gas can be generally represented to a user by indicia such as the “OFF” label and the flame labels as shown in FIG. 11. The indicia may include letters, words, phrases, etc. For example, the indicia may include the word “HIGH”, “MEDIUM”, “MED”, and/or “LOW”, etc.

The indicia disclosed herein may represent discrete positions for a particular amount of flammable gas. For example, the indicia may include a low position, a high position, and an off position representing the only three levels of flammable gas available to a user. In other examples, the indicia may represent one or more positions on an analog scale ranging from no flammable gas to a particular amount of flammable gas.

Additionally, the ignition system 1104 may include a device that allows the flow of flammable gas from the gas port system 1102 after the flammable gas is ignited. For example, and in the particular example of FIG. 12, the ignition system 1104 includes a thermocouple 1216 coupled between the gas port system 1102 and the gas burner 1114. The thermocouple 1216 is latchable to allow flammable gas to flow to the gas burner 1114 when the controller 1214 is actuated. For example, the thermocouple 1216 may latch in response to a user manipulating the controller 1214 to ignite the gas burner 1114 and after an internal temperature (e.g., of the thermocouple 1216) reaches a defined value, after a defined period of time (e.g., 0.5 seconds, 1.5 seconds, 3 seconds, 5 seconds, etc.), etc. The thermocouple 1216 may unlatch after a temperature (e.g., of the thermocouple 1216, adjacent the gas burner 1114, etc.) is equal to, below, or above a defined value. For example, the thermocouple 1216 may unlatch based on a sensed temperature thereby blocking flammable gas from passing through conduits in the housing 1118 and to the gas burner 1114 when a flame from the gas burner 1114 is extinguished, reduces below a undesirable level, etc.

As shown in FIG. 11, the gas port system 1102 includes an input gas port 1218 that is removably coupled to a source of flammable gas. The input gas port 1218 may be shaped, sized, etc. to mate with conventional sources of flammable gas. For example, the gas port 1218 may include one or more conventional couplings for attaching the gas source to the removable unit 1100 via a hose or the like. The input gas port 1218 may include one or more quick connect/disconnect couplings if desired. Although not shown, the gas port system 1102 may include a shutoff valve (e.g., an emergency shutoff valve, etc.) to prohibit the fuel from reaching the gas burner 1114.

The functions of the controller 1214 may be performed by different user input components. In such cases, one component can be manipulated to adjust an amount of flammable gas received by the gas burner 1114 and another component can be manipulated to ignite the gas burner 1114.

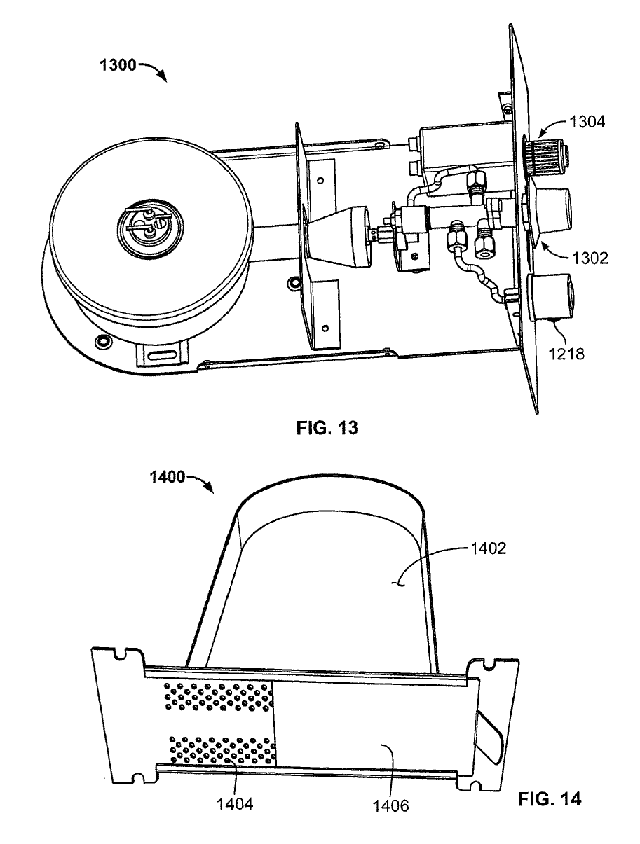

For example FIG. 13 illustrates an example removable gas unit 1300 substantially similar to the removable gas unit 1100 of FIGS. 11 and 12. The removable gas unit 1300 includes a gas port system having the input gas port 1218 of FIG. 11, and a gas control system 1302 and an ignition system 1304. Similar to the controller 1214 of FIG. 12, the gas control system 1302 of FIG. 13 may include a rotatable user input to control an amount of flammable gas. The ignition system 1304 includes a user input (e.g., a push bottom) to generate a spark to ignite the flammable gas from the gas port system. In the particular example of FIG. 13, the ignition system 1304 includes an electronic igniter.

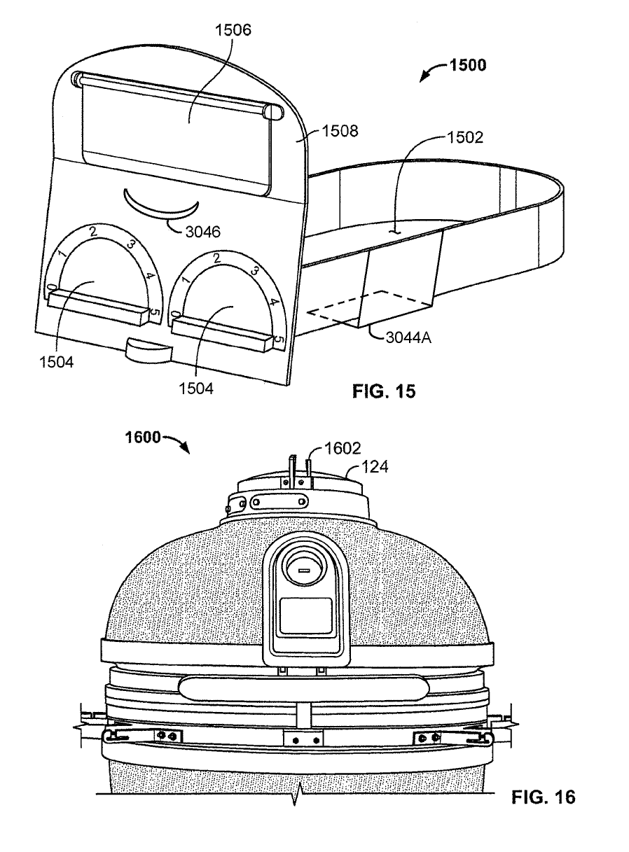

As explained above, a vessel may receive more than one removable unit. For example, one removable unit (e.g., the removable gas unit 110, 210, 1100 & 1300) may be removed, and another removable unit may be inserted into the vessel as explained above. The other removable unit may be, for example, an unit including a receptacle for collecting ashes from burnt charcoal, one or more vents to allow air to flow through the kamado-style grill, opening(s) for receiving a fire starter, etc. For example, FIGS. 14 and 15 illustrate removable units 1400, 1500 (sometimes referred to as removable charcoal units) insertable through an opening of a vessel for positioning below a fire bowl opening, as explained above.

As shown in the FIG. 14, the removable charcoal unit 1400 includes an ash tray 1402, a vent (e.g., perforations 1404), and a vent cover 1406 for controlling the amount of air passing through the perforations 1404. In the particular example of FIG. 14, the vent cover 1406 is slidable to alter the number of perforations 1404 covered by the vent cover 1406.

The removable charcoal unit 1500 of FIG. 15 includes an ash tray 1502, two vent covers 1504 for controlling the amount of air passing through vents (not shown), and a movable cover 1506 that covers an opening (not shown) for receiving a fire starter. In the particular example of FIG. 15, the vent covers 1504 are rotatable to alter the amount of area of the vents covered by the vent covers 1504. Additionally, the cover 1506 is pivotally coupled via one or more hinges to a faceplate 1508 of the unit 1500 to allow the cover 1506 to move thereby exposing the fire starter opening.

Although FIGS. 11-15 illustrate removable units each including specific components (e.g., the user inputs, controls, vents, etc.) at specific locations, it should be apparent that any one of the removable units may have more or less components including components of another removable unit. Additionally, the components of any one of the removable units may be positioned at any suitable location. For example, the removable gas unit 1100 of FIGS. 11 and 12 may include a push bottom ignition system (e.g., similar to the ignition system 1304 of FIG. 13) to generate a spark to ignite the flammable gas from the gas port system. This push bottom ignition system can be positioned adjacent to the input gas port 1218, the controller 1214, etc.

The kamado-style grills disclosed herein may include various different optional features. For example, one or more of the kamado-style grills may include an upper shell or lid coupled (e.g., detachably coupled, pivotally coupled, etc.) to a vessel. The upper shell or lid may include an optional vent system positioned adjacent a top of the kamado-style grills.

For example, and as shown in FIG. 1, the grill 100 includes an upper shell 116 coupled to the vessel 102 and a vent system 118 coupled to a top portion of the upper shell 116. In the particular example of FIG. 1, the upper shell 116 is pivotally coupled to the vessel 102 via one or more hinges 120. The vent system 118 includes one or more vents (e.g., openings, etc.) 122 to allow air, smoke, etc. to exhaust from the interior of the grill 100 and a vent cover 124 movable relative to the vent(s) for controlling the amount of air, smoke, etc. flowing through (and out of) the grill 100. The vent system 118 may work in conjunction with, for example, vent(s) of the charcoal units 1400, 1500 of FIGS. 14 and 15.

The vent cover may be locked in a particular position. For example, FIG. 16 illustrates a portion of a kamado-style grill 1600 substantially similar to the kamado-style grill 100 of FIG. 1. The grill 1600, however, includes a vent lock 1602 detachably coupled to the vent cover 124. When employed, the vent lock 1602 substantially prevents the vent cover 124 from moving relative to the vent(s) (not shown in FIG. 16). In some circumstances, it may be desired to keep the vents at least partially open, closed, etc. For example, if a removable gas unit is employed, it may be desired to keep the vents at least partially open in case a flame is extinguished and flammable gas continues to flow out of its gas burner. This may ensure the flammable gas can flow out of the kamado-style grill 1600.

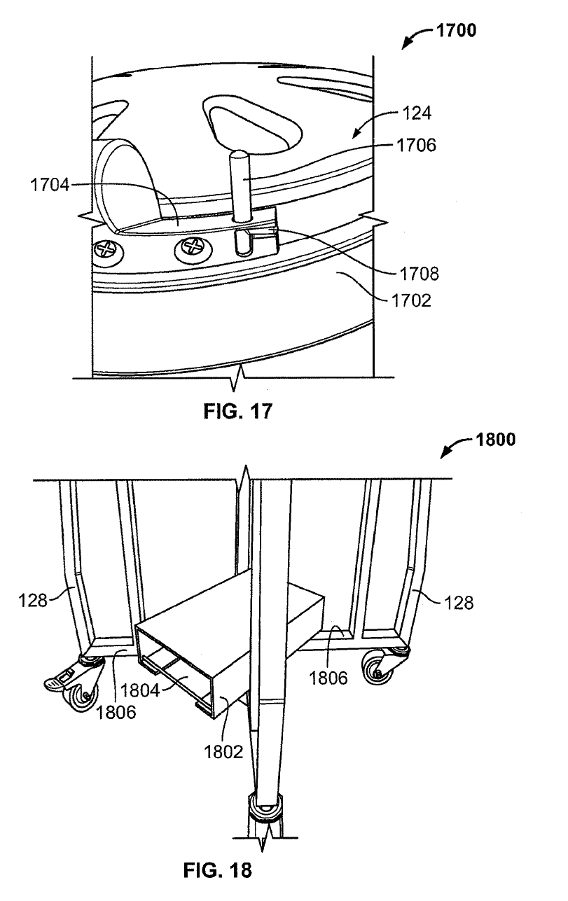

The vent lock 1602 may include various different suitable devices that substantially prevent the vent cover 124 from moving. For example, FIG. 17 illustrates a vent system 1700 substantially similar to the vent system 118 of FIG. 1. The vent system 1700 includes a vent lock, a static platform 1702 that defines vent(s) (not shown in FIG. 17), and the vent cover 124 of FIG. 1 rotatably coupled to the platform 1702. In the particular example of FIG. 17, the vent lock includes a plate 1704 coupled to the vent cover 124 and defining an opening, and a pin 1706 slidable through the plate opening and removably coupled to the platform 1702 to substantially prevent the vent cover 124 from rotating relative to the vent(s). For example, the pin 1706 may be removably coupled to the platform 1702 by positioning the pin in an opening defined by the platform 1702. Alternatively, other suitable vent locks may be employed without departing from the scope of the disclosure.

As shown in FIG. 17, the pin 1706 can include a protruding member 1708. In such examples, the plate 1704 includes a cutout or the like that corresponds to the protruding member 1708. As such, if it is desired to prevent the vent cover 124 from moving, a user can rotate the pin 1706 such that the protruding member 1708 rotates away from the cutout to allow the pin 1706 to fall into the opening defined by the platform 1702. If it is desired to allow the vent cover 124 to move, a user can manipulate the pin 1706 such that the protruding member 1708 is adjacent the cutout of the plate 1704, as shown in FIG. 17.

Additionally and/or alternatively, the kamado-style grills disclosed herein may include an optional support frame for supporting the chamber, the fire bowl, and/or the lid. For example, the grill 100 of FIG. 1 includes a support frame 126 includes four legs 128 and wheels 130 (e.g., casters, etc.) coupled to the legs 128. As such, the grill 100 can be supported by the support frame 126 and be moved as desired.

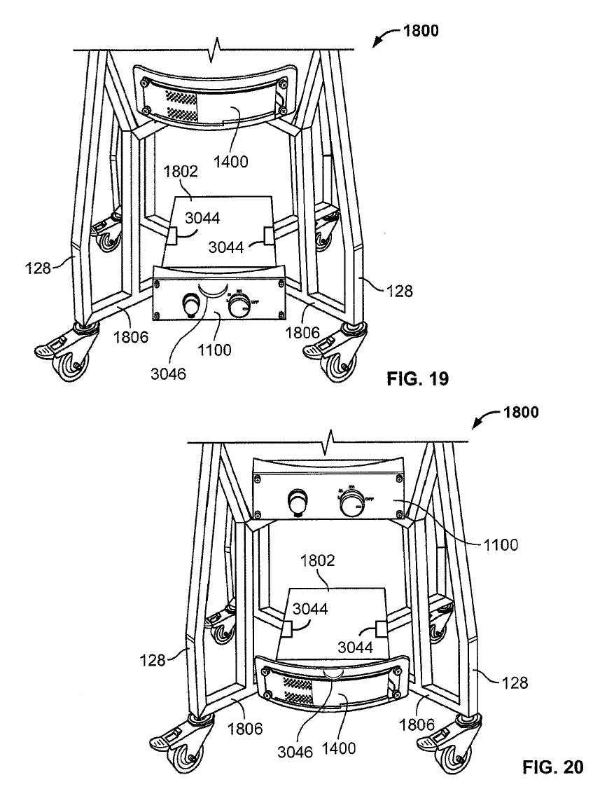

The grills may include a sleeve for receiving a removable unit (e.g., one of the removable unit disclosed herein, etc.). For example, FIG. 18 illustrates a support frame 1800 of a kamado-style grill substantially similar to the support frame 126 of FIG. 1, but including a sleeve 1802 coupled to the support frame 1800. As shown, the sleeve 1802 defines an opening 1804 for receiving a removable unit. This allows a user to store the removable unit in the sleeve 1802 and use another removable unit for cooking purposes (if desired), as explained above. Thus, the sleeve 1802 can store the non-used removable unit when the other removable unit is inserted into the vessel.

For example, and as shown in FIG. 19, the removable gas unit 1100 of FIGS. 11 and 12 is positioned in the sleeve 1802 via its opening (not shown), and the removable charcoal unit 1400 of FIG. 14 is inserted in the vessel, as explained above. In other examples, the removable charcoal unit 1400 is positioned in the sleeve 1802, and the removable gas unit 1100 is inserted in the vessel, as shown in FIG. 20. Alternatively, other suitable removable units may be used if desired.

The support frame 1800 includes a base 1806 and the legs 128 extending between the base 1806 and a vessel. As shown in FIGS. 18-20, the sleeve 1802 is coupled to the base 1806 between the legs 128. As such, the sleeve 1802 is coupled to the support frame 1800 such that the opening 1804 extends in a substantially parallel direction relative to the ground supporting the grill. Alternatively, the sleeve 1802 may be coupled to the legs 128 and/or another suitable structure of the support frame 1800, grill, etc., and/or be orientated in another suitable manner (e.g., substantially perpendicular position relative to the ground, etc.).

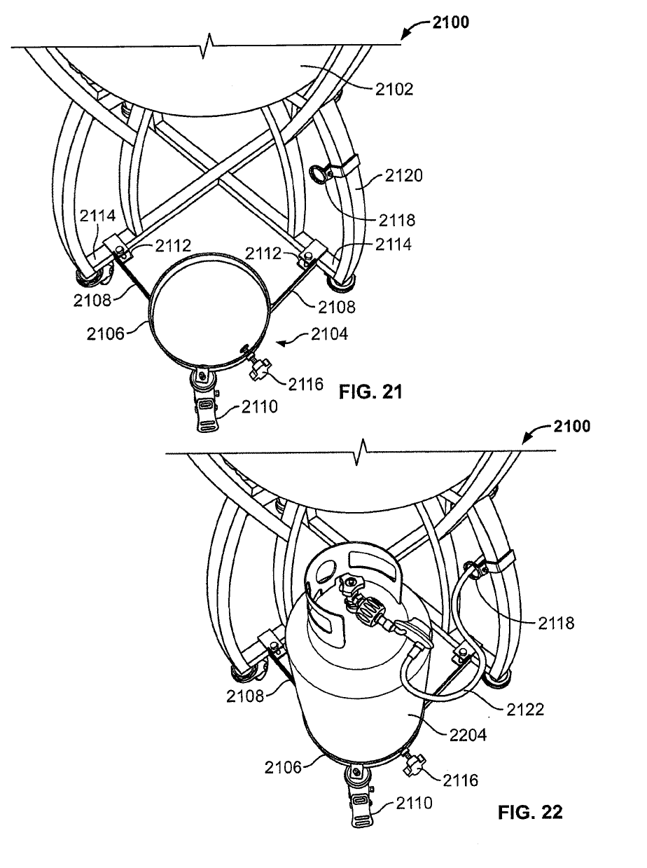

Additionally and/or alternatively, the kamado-style grills may include an optional cart to support a gas source coupled (e.g., detachably coupled, etc.) to the support frame. For example, FIGS. 21 and 22 illustrate a support frame 2100 for supporting a vessel 2102 of a kamado-style grill, and a cart 2104 coupled to the support frame 2100. The cart 2104 may be coupled to the support frame 2100 via any suitable device, process, etc. For example, the cart 2104 may be welded to the frame 2100, coupled to the frame 2100 via one or more fastening devices (as shown in FIGS. 21 and 22), etc.

In the particular example of FIGS. 21 and 22, the cart 2104 includes a frame 2106 for supporting a gas source 2204, two bars 2108 extending between the frame 2106 and the support frame 2100, a wheel 2110 (e.g., a caster, etc.) coupled to the frame 2106, and mechanical fasteners 2112 for coupling the bars 2108 (and therefore the cart 2104) to the support frame 2100. The mechanical fasteners 2112 include a bracket that corresponds (e.g., shape, size, etc.) to a base 2114 of the support frame 2100 and a fastening device (e.g., a screw, a nut, a pin, etc.) for detachably coupling the bracket to the base 2114. As such, the cart 2104 may be coupled to the support frame 2100 via the mechanical fasteners 2112 such that the cart 2104 is attached to the kamado-style grill when the grill is used as a gas fired grill and detached from the kamado-style grill when the grill is used as a charcoal fired grill.

The frame 2106 may include an “I” shaped support formed into a substantially circular shape corresponding to a cross sectional shape of the gas source 2204. For example, the inner circumference of the frame 2106 may be slightly larger than an outer circumference of a portion of the gas source 2204 such that this portion of the gas source is able to extend into the circular shaped support when the gas source is coupled to the frame 2106. Although not shown, the frame 2106 may include one or more cross beams extending across the circular shaped support to provide additional stability, support, etc. Alternatively, other suitable supports formed into a different shape may be employed if desired.

As shown in FIG. 22, the gas source 2204 is coupled to the frame 2106 by resting on top of the support (and cross beams if employed), by manipulating one or more mechanical fasteners (e.g., screws, bolts, pins, nuts, etc.), etc. For example, the frame 2106 of FIGS. 21 and 22 includes a mechanical fastener 2116 that detachably couples the gas source 2204 to the cart 2104. In the particular example of FIGS. 21 and 22, the mechanical fastener 2116 includes a bolt and a rotatable knob coupled to the bolt allowing a user to rotate the bolt. The bolt can be rotated a desired amount such that the bolt is pressed against the gas source thereby securing the gas source in place.

The frame 2106 may be adjustable. For example, one or more mechanical fasteners may be manipulated to reduce and/or increase the size of the circular shaped support to accommodate various sized gas sources. Additionally and/or alternatively, one or more mechanical fasteners may be employed to change the shape of the frame 2106 to accommodate various shaped gas sources.

As shown in FIG. 22, the gas source 2204 may be detachably coupled to a gas unit (if employed) via a flexible hose 2122 as explained above. Alternatively, one or more other suitable conduits including other types of flexible hoses may be employed.

If desired, the hose 2122 can be secured to one or more legs 2120 of the support frame 2100 to ensure the hose does not interfere with the wheels of the kamado-style grill and/or the wheel 2110 of the cart 2104. For example, one or more routing devices 2118 may be coupled to the support frame 2100. As shown best in FIG. 21, the routing device 2118 includes a bracket coupled to one leg 2120 and a circular support coupled to the bracket. The hose 2122 can pass through the circular support of each routing device 2118 thereby securing the hose 2122 to the support frame 2100. Alternatively, other suitable devices such as clamps, etc. may be employed to secure the hose 2122 to the support frame 2100 and/or route the hose 2122 to the gas unit.

Preferably, the cart 2104 is coupled to the support frame 2100 and the gas source 2204 is coupled to the gas unit after the heat spreader 112 (if used) and the structure 902 (if used) are installed, as explained above. The cart 2104 may be coupled to the support frame 2100 and/or the gas source 2204 may be coupled to the gas unit before or after the gas unit is installed (as explained above), before the heat spreader 112 and/or the structure 902 are installed (as explained above), etc. if desired.

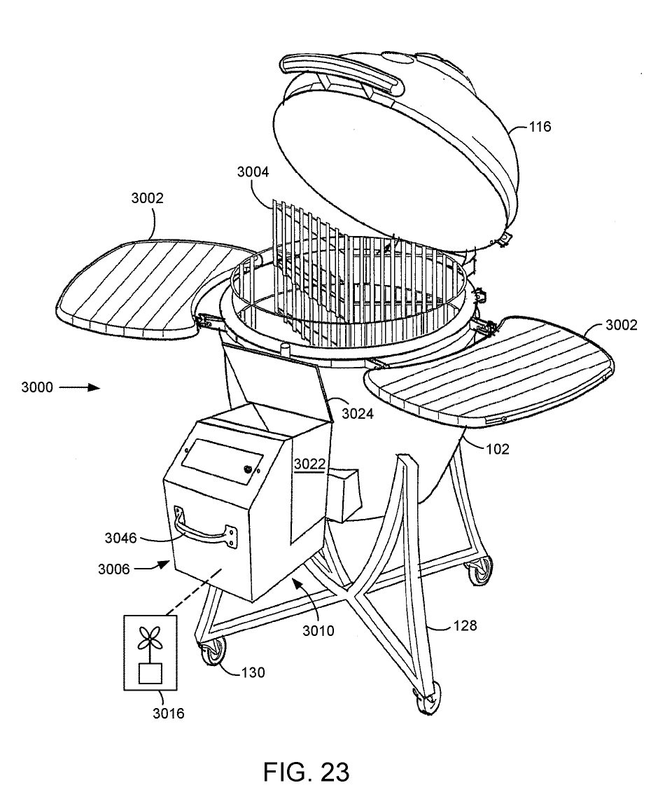

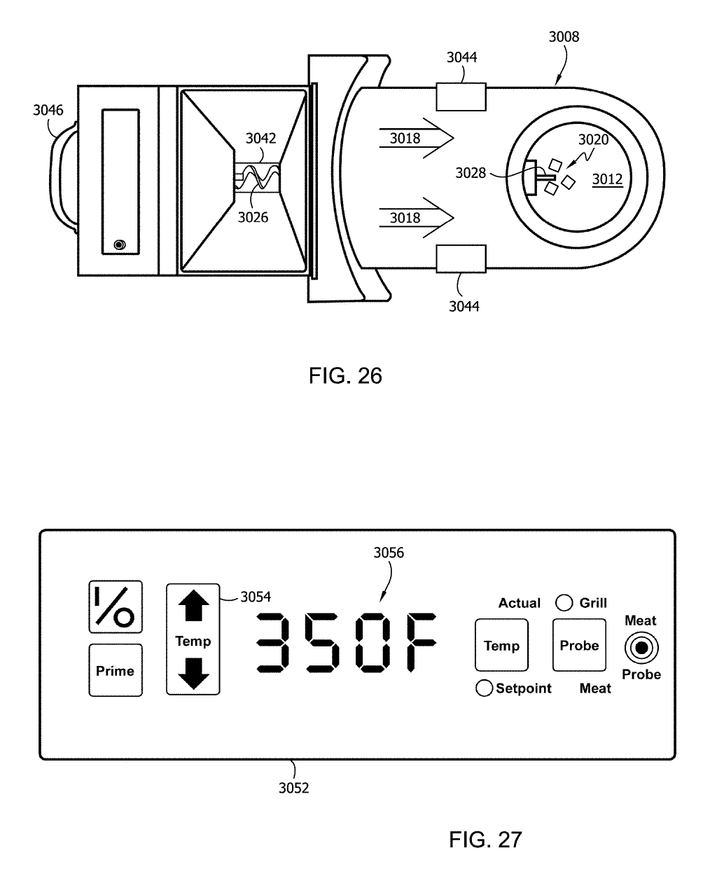

FIGS. 23 and 24 show a grill 3000 supported on a support frame 126 having four legs 128 and wheels 130. Grill 3000 is shown there fueled by a pellet burner 3006. FIGS. 25 and 26 (top down view) show additional detail for the structure of the pellet burner 3006. FIG. 27 shows the control panel 3052 for controlling the pellet burner 3006.

More particularly, grill 3000 includes optional working surfaces 3002 on either side. Grill 3000 includes an upper shell 116 and a lower shell 102. Lower shell 102 defines an opening 104 there-through. Upper shell 116 and lower shell 102 together define a cooking chamber as seen in the space where the grate 3004 is found. Grate 3004 is used to support the food that will be cooked in the grill 3000. Lower shell 102 is substantially constructed from a clay, ceramic, refractory material, earthen material, cement rock, or terra cotta composition. The pellet burner 3006 is adapted to fit in the opening 104 in the lower shell 102. The pellet burner 3006 includes an air duct 3008 having a first end 3010 and a second end 3012, wherein the first end 3010 is positioned outside of the lower shell 102 and the second end 3012 is positioned inside of the lower shell 102 when the pellet burner 3006 is fitted in the opening 104 in the lower shell 102.

A fan 3016 is positioned at the bottom of the housing for the pellet burner 3006 to draw air into the housing through holes (not shown) that provide the first end 3010 of the air duct 3008. Fan 3016 blows air through the air duct 3008 as shown by arrows 3018 and through the second end 3012 of the air duct via air holes such as those shown by reference character 3014. Thus, the pathway for the air through air duct 3008 as driven by the fan 3016 is that the air enters the first end 3010 of the air duct 3008 via holes (not shown) in the underside of the base of the pellet burner 3006. The air is then pushed through the air duct as indicated by arrows 3018 towards the second end 3012 where the air exits the air duct via holes 3014. This air is used to support the combustion of exemplary pellets 3020 shown in FIG. 26.

The pellet burner 3006 includes a pellet box 3022 configured to hold a plurality of pellets. Pellet box 3022 includes a lid 3024. Lid 3024 is shown in the open position in FIG. 23. The sidewalls of pellet box 3022 preferably provide a funnel effect to direct the pellets to an auger 3026 positioned at the bottom of the pellet box 3022. Auger 3026 is configured to move pellets from the pellet box 3022 to a position adjacent the second end 3012 of the air duct 3008. A hot rod 3028 is positioned adjacent the second end 3012 of the air duct 3008 to ignite the pellets delivered by the auger 3026. The floor at the second end 3012 of air duct 3008 holds the pellets as they burn.

The pellet burner 3006 includes a gasket 3030. The gasket 3030 is adapted to seal the opening 104 in the lower shell 102 when the pellet burner 3006 is fitted in the opening 104. The grill further comprising a latch (not shown) for releasably securing the pellet burner 3006 in the opening 104 in the lower shell 102. As seen, the second end 3012 of the air duct 3008 is positioned in a center position of the lower shell 102 when the pellet burner 3006 is fitted in the opening 104. A metal heat exchanger 3032 is adapted to be positioned at the second end 3012 of the air duct 3008. The metal heat exchanger 3032 preferably comprises a perforated cylindrical side wall 3034 and an unperforated flat top surface 3036. When in position over the second end 3012, the heat exchanger 3032 is sized to cover a plurality of burning pellets thereunder. A lava stone 3038 is supported with brackets 602 adapted to locate the lava stone 3038 above the metal heat exchanger 3032. A mesh screen 3040 is preferably sized to fit adjacent an interior surface of the metal heat exchanger 3032 to contain smaller ash particles. In use, the metal heat exchanger 3032 and the lava stone 3038 are preferably positioned over the second end 3012 of the air duct 3008 in a center position of the lower shell 102 when the pellet burner 3006 is fitted in the opening 104 in the lower shell 102.

Fan 3016 is positioned to both blow air through the air duct 3008 and also to apply a positive air pressure to the pellet box 3022 which is relieved through a passage 3042 containing the auger 3026.

Pellet burner 3006 may include a guide 3044 secured thereto for slidably mounting the pellet burner 3006 in the opening 104 in the lower shell 102. Lower shell 102 may include a corresponding track 3045 shown in phantom box 3060. Track 3045 is mounted inside the lower shell 102 to receive the pellet burner 3006. A handle 3046 secured to the pellet burner 3006 facilitates removal of the pellet burner 3006 from the lower shell 102. Guide 3044 is shown to have a cross section in the shape of a “C,” such as that made from channel iron or any other suitable material. Guide 3044 may also be made from angle iron or any other suitable material such as that shown for guide 3044A attached to the removable charcoal unit 1500 in FIG. 15. Guides 3044 or 3044A may be attached to any pellet burner 3006, gas burner 210, charcoal unit 1500, or ash tray 1502 to make it easier to slidably mount these removable units in the opening 104. Alternatively, if the structure of such removable unit is sized for the opening 104, then guides 3044 or 3044A may not be needed, or may be used to strengthen the contact portion of the removable unit and/or protect it from wear. Track 3045 may also be used inside the lower shell 102 to receive such removable units and support them in position during grilling. Track 3045 is shown to have a cross section in the shape of a “C,” such as that made from channel iron or any other suitable material. Track 3045 may also be made from angle iron or any other suitable material. FIGS. 2, 15, 19-20, 24 and 26 show the optional guides 3044/3044A connected to the respective removable receptacles shown there. The removable receptacles shown in FIGS. 1, 6, 10-14 and 25 do not include such optional guides.

Grill 3000 preferably includes a temperature sensor 3048 adapted to sense a temperature in the cooking chamber and/or a temperature sensor 3050 adapted to sense a temperature of a piece of food in the cooking chamber. A control panel 3052 includes an input switch 3054 adapted to provide a signal 3056 indicative of a desired temperature in the cooking chamber. A control circuit (not shown) is responsive to the temperature sensors 3048 and 3050 and the input switch 3054 for controlling a speed of the fan 3016 and a rate at which the auger 3026 moves pellets from the pellet box 3022 to a position adjacent the second end 3012 of the air duct 3008 as a function of the sensed temperature and the desired temperature. The speed of the fan 3016 is preferably increased and decreased with respective increases and decreases in the speed of the auger 3026 to provide an appropriate amount of combustion air given the rate at which the augered pellets are to be burned to maintain the desired temperature in the cooking chamber.

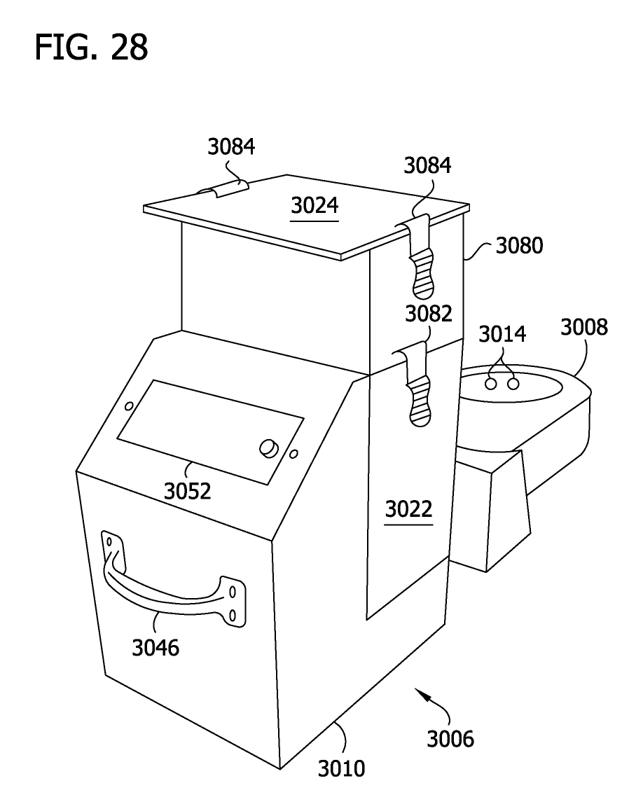

FIG. 28 shows pellet burner 3006 with a larger capacity for holding more pellets. Pellet burner 3006 includes pellet box 3022, as in the above description, but it also has an extension box 3080 secured to the top of pellet box 3022 by a pair of mechanical latches 3082. Extension box 3080 can be filled with pellets in addition to the pellets held by pellet box 3022 to extend the fuel capacity of the grill and to allow for additional hours of grilling without the need to add more pellets. As seen, lid 3024 for pellet box 3022 also fits on top of extension box 3080 and is held securely thereto by a second pair of mechanical latches 3084.

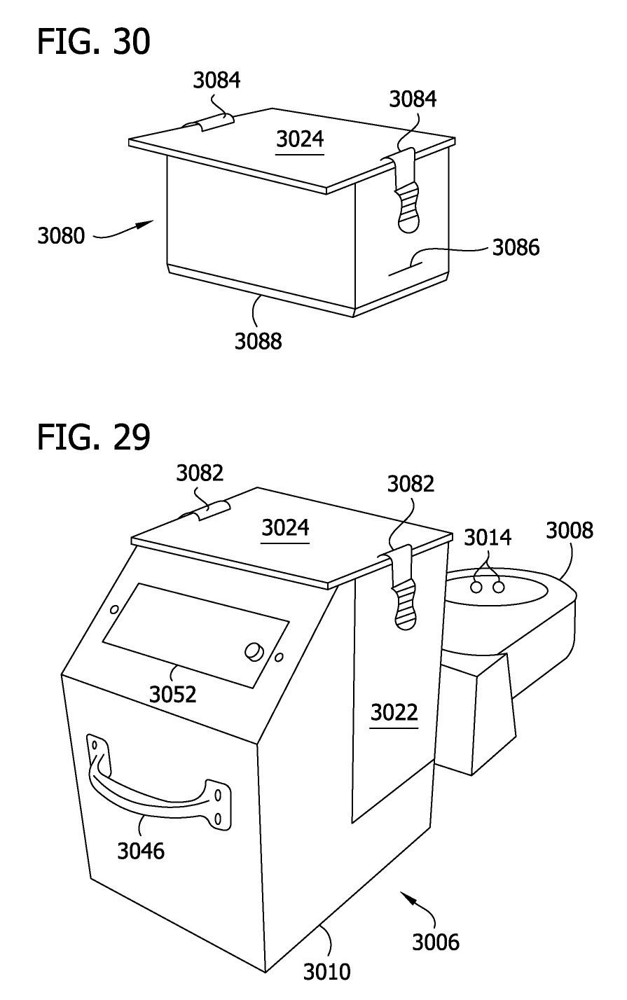

FIG. 29 shows pellet burner 3006 with the extension box 3080 removed. As seen, lid 3024 is held securely over the pellet box 3022 by mechanical latches 3082.

FIG. 30 shows the extension box 3080 standing alone. Extension box 3080 includes a groove 3086 for receiving the gripping end of latch 3082 for when the extension box 3080 is secured on pellet box 3022. Extension box 3080 may include tapered edges 3088 for a good fit with pellet box 3022. Again, lid 3024 is shown securely held to the top of extension box 3080 by latches 3084

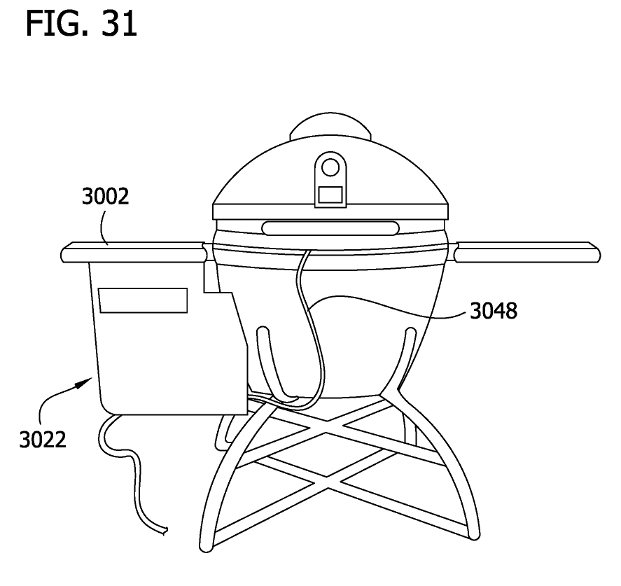

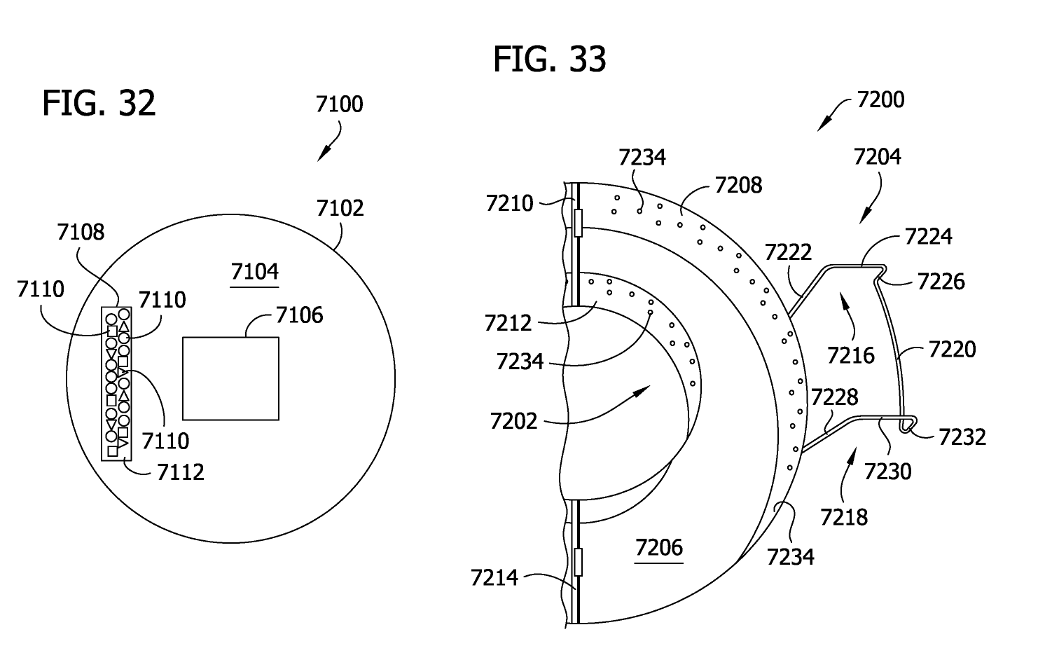

As shown in FIG. 31, the pellet box can be located beneath one of the shelves if desired by loosening the metal banding in order to reposition the shock absorber, shelves and hinge on the lower shell. FIG. 31 shows a grill similar to the grill of FIG. 23 wherein the pellet box 3022 is repositioned clockwise by 90 degrees, and then the banding is tightened down onto the lower shell.

Upper shell 116 and lower shell 102 of grill 3000 are preferably both constructed from a clay or ceramic composition.

A benefit of grill 3000 is that it can be fueled by pellet burner 3006 for burning wood pellets or other common pellet fuel, or if preferred, by a gas burner that is interchangeable with the pellet burner 3006. For example, the gas burners shown in FIGS. 1 & 6 (see insert 110); 2 (see insert 210); 11, 12, 19 & 20 (see removable gas unit 1100); and 13 (see removable gas unit 1300) are adapted to fit in the opening 104 in the lower shell 102 and can each be used interchangeably with pellet burner 3006. Again, such gas burners may use a propane gas burner with a metal heat exchanger positioned in a center position of the lower shell 102 when the gas burner is fitted in the opening 104.

Relatedly, a further benefit of grill 3000 is that it can also be fueled by conventional charcoal or wood. For example, the ash trays shown in FIGS. 14 (1402) and 15 (1502) can be used with the fire bowl 106 supported by the lower shell 102 in FIG. 6 to burn charcoal or wood. As seen, these ash trays are adapted to collect ash dropped from the fire bowl 106 and can each be used interchangeably with pellet burner 3006. These ash trays may be used with the other structures shown there, including the vents 1404 and vent covers 1406/1504 (covering vents not shown) for controlling the amount of air passing through the vents.

It is thus apparent to a person of ordinary skill in the art that grill 3000 may be readily fueled with pellets via an automatic feeder, with a propane burner, or with conventional charcoal or wood by simply replacing one fuel source for the other in opening 104 of lower shell 102.

The lower shell 102 and upper shell 116 may include a cavity respectively therein wherein each such cavity contains an insulation material (not shown).

The shell of the grill may be made with a material that has good insulation properties, such as clay, ceramic, refractory material, earthen material, cement rock, or terra cotta material. In some situations, the shell may be made using less expensive materials such as metal. A steel kettle may also be used.

The burner of the gas units (including the removable gas units, etc.) disclosed herein may include various different types of burners. For example, the gas units may include an infrared burner as shown in FIGS. 11 and 12, an open flame burner (or the like) as shown in FIG. 14, etc.

The flammable gas disclosed herein may include any suitable combustible gas, a combination of combustible gases, a combination of combustible gases and noncombustible gases, etc. For example, the gas may include natural gas, propane and/or another suitable gas. The flammable gas may be provided via a gas source such as a refillable tank (e.g., a propane tank), a gas line from a home gas system, etc.

Turning to FIG. 28, a kamado-style grill for cooking food according to one example embodiment of the present disclosure is illustrated and indicated generally by reference number 7100. As shown in FIG. 28, the kamado-style grill 7100 includes a fire bowl 7102 defining an interior 7104, a heat source 7106 adapted to heat the interior 7104 of the fire bowl 7102, and a container 7108 disposed in the grill 7100 (and preferably in the fire bowl 7102). The container 7108 is adapted to hold a flavorizing material that, when heated by the heat source, alters the flavor of food cooked by the grill.

The container 7108 is preferably comprised of metal, but could also be comprised of an earthen material.

The heat source 7106 may heat the interior 7104 of the fire bowl 7102 to cook food in the grill 7100. This heat may cause the flavorizing material 7110 in the container 7108 (sometimes referred to as a smoke tray) to smoke, which in turn may enhance or otherwise alter the flavor of food cooked in the grill 7100. For example, the food cooked in the grill 7100 may have a smoked flavor, a charcoal flavor, etc.

In some preferred embodiments, the heat source 7106 includes a flammable gas heat source, as further explained below. In other examples, the heat source 7106 may include another suitable heat source such as a charcoal heat source, pellet burner 3006 in FIGS. 23 to 25, electric heat source, or similar heat source.

In some examples and as shown in FIG. 28, the container 7108 includes a base 7112 for holding (e.g., supporting, etc.) the flavorizing material 7110. Additionally, the container 7108 may include one or more walls extending from the base 7112 to at least partially surround the flavorizing material 7110 when placed in the container 7108 (e.g., on the base 7112, etc.). A lid (not shown) may be positioned over the top of container 7108. The lid may define openings to let air pass into and out of the container 7108 to allow smoke and/or flavorings into the cooking chamber. Alternatively, the container 7108 may not include side walls extending from the base 7112.

Although the grill 7100 is shown to include one container 7108 in FIG. 28, the grill 7100 may include one or more containers without departing from the scope of this disclosure. For example, the grill 7100 may include two or more containers 7108 having the same or different configurations if desired.

Additionally, the container 7108 may have any suitable shape. For example, and as shown in FIG. 28, the container 7108 may have a rectangular shape. In other embodiments, the container 7108 may have a circular shape, a triangular shape, an arcuate shape, etc. For example, FIG. 33 illustrates a container 7200 that is substantially similar to the container 7108 of FIG. 28, but having a arcuate shape. The container 7200 may be employed in the grill 7100 of FIG. 28 (and/or any other suitable grill including those disclosed herein). When employed in the grill of FIG. 28, the container 7200 may be used instead of and/or in addition to the container 7108.

As shown in FIG. 33, the container 7200 includes a receptacle 7202 and a handle 7204 extending from the receptacle 7202. The receptacle 7202 includes a base 7206, and four walls 7208, 7210, 7212, 7214 extending from the base 7206. As shown, the walls 7208, 7212 are formed into arcs to form the arcuate shaped container 7200. The receptacle 7202 may hold flavorizing material (not shown) that alters (e.g., enhances) the flavor of food cooked in the grill, as explained above.

In the particular example of FIG. 33, the handle 7204 has a “J” shaped profile that facilitates moving (e.g. removing, manipulating, etc.) the container 7200 by hand. For example, a user may grasp a portion of the handle 7204 and place the container 7200 in the grill 7100 of FIG. 28, remove the container 7200 from the grill 7100 (e.g., for cleaning the container 7200, removing spent flavorizing material, etc.), etc.

As shown, the handle 7204 includes two portions 7216, 7218 extending parallel to each other and forming the “J” shaped profile. The portions 7216, 7218 each include one end attached to the wall 7208 and/or the base 7206, and another end coupled together via a cross brace 7220.

The portions 7216, 7218 each include three segments 7222, 7224, 7226, 7228, 7230, 7232. As shown, the segments 7222, 7226 of the portion 7216 and the segments 7228, 7232 of the portion 7218 extend in substantially parallel planes, and the segment 7224 of the portion 7216 and the segment 7230 of the portion 7218 extend in substantially parallel planes. As shown, the segments 7224, 7230 extend in plane(s) substantially perpendicular to the segments 7222, 7226, 7228, 7232. In other embodiments, the handle 7204 may include more or less portions and/or segments orientated the same or differently.

In some embodiments, and as further explained below, the handle 7204 may be shaped for coupling to a fire bowl (e.g., a rim of one of the fire bowls disclosed herein). For example, when the container 7200 is positioned in the grill (and/or the fire bowl), the segments 7224, 7230 may rest on a top rim of a fire bowl, the segments 7222, 7228 may be positioned on an interior side of the fire bowl, and the segments 7226, 7232 may be positioned on an exterior side of the fire bowl.

Additionally, one or more of the walls may define openings for allowing air to pass through the receptacle 7202. For example, and as shown in FIG. 33, the walls 7208, 7210, 7212, 7214 each include multiple openings 7234. These openings 7234 allow air including oxygen to facilitate combustion of the flavorizing material (if desired), and/or move smoke from the container 7200. A lid (not shown) may be positioned over the top of receptacle 7202. The lid may define openings to allow air to pass through.

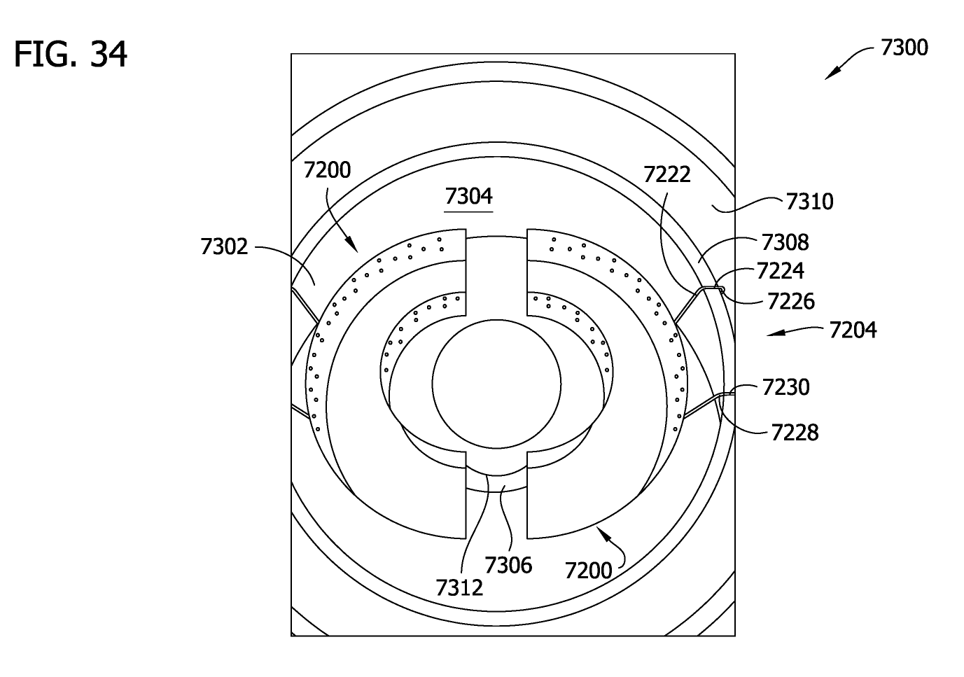

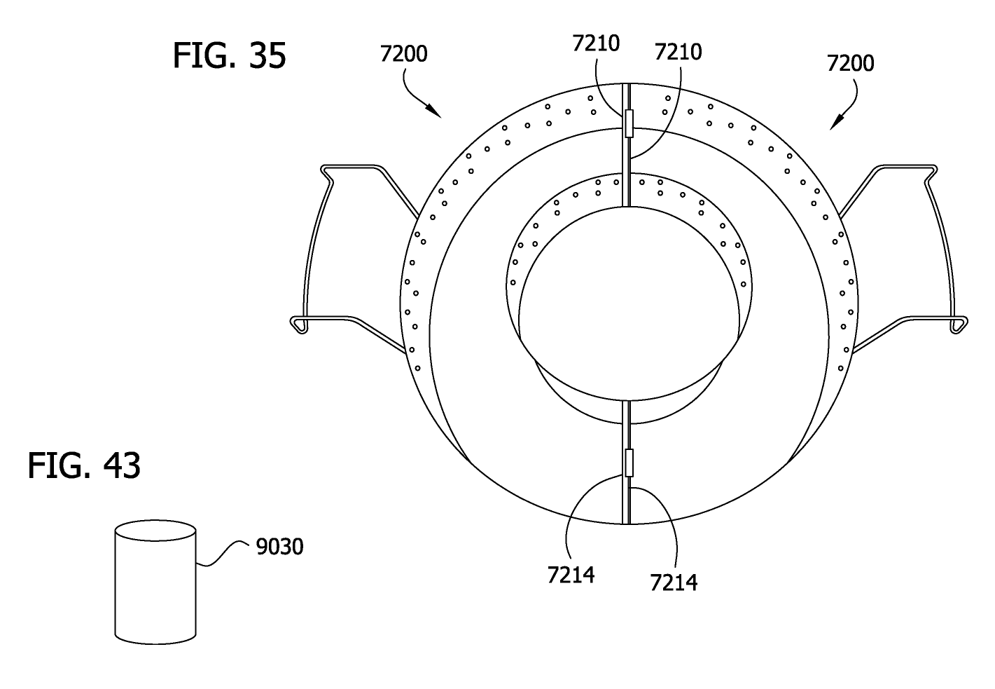

FIG. 34 illustrates another example of a kamado-style grill 7300 including a fire bowl 7302 defining an interior 7304, a heat source 7306 for heating the interior 7304 of the fire bowl 7302, and two of the containers 7200 of FIG. 33 removably coupled to the fire bowl 7302. As shown, the containers 7200 are coupled to the fire bowl 7302 on opposing sides of the fire bowl 7302 in a mirroring configuration. In other examples, the containers 7200 may be coupled adjacent each other (e.g., side-by-side containers, contacting containers, etc.), etc. For example, FIG. 35 illustrates two mirrored containers 7200 of FIG. 33 abutted against each other, and that are configured to substantially extend about the full perimeter (e.g., the circumference) of a grill, a fire bowl, etc. The mirrored containers 7200 of FIG. 35 may be employed in any suitable kamado-style grill including the grill 7300 of FIG. 34. Alternatively, the structure shown by the two containers 7200 in FIG. 35 could be constructed as a single circular container having an opening about the center to provide room for a gas burner, pellet burner, and/or heat spreader as same are shown in the various figures disclosed herein. Such a single circular container could be made without end walls 7210 and 7214 to provide a container without any internal obstructions. Such a single circular container would thus be configured as a hollow cylinder wherein the interior wall is an inner cylinder, the exterior wall is an outer cylinder, the floor is a base circle adjoining the inner and outer cylinders, and the volume of the hollow cylinder is adapted to hold charcoal, wood, or other flavorizing material.

As shown in FIG. 34, the fire bowl 7302 includes a rim 7308 adjacent a top portion of the fire bowl 7302. The containers 7200 may be coupled (e.g., removably coupled) to the rim 7308 when the containers 7200 are disposed in the grill 7300. For example, and as shown, the segments 7224, 7230 of each handle 7204 rest on the top rim 7308 of the fire bowl 7302. In such examples, the segments 7222, 7228 of each handle 7204 are positioned on the interior side of the fire bowl 7302, and the segments 7226, 7232 of each handle 7204 are positioned on the exterior side of the fire bowl 7302, as explained above.

The containers 7200 may have the same or different shapes, sizes, etc. In some examples, the handle 7204 of one or both containers 7200 may be longer and/or shorter than the handles shown, the handle(s) 7204 may be angled differently (relative to the fire bowl 7302), the receptacle 7202 of one or both containers 7200 may have a different shape (e.g., a rectangular shape), etc. The configuration of the container(s) 7200 may depend on, for example, the size and/or shape of the fire bowl 7302.

Although the grill 7300 is shown to include two mirrored containers 7200 for holding flavorizing material, it should be apparent to those skilled in the art that the grill 7300 may include different containers in addition to and/or in place of the two containers 7200 of FIG. 34. For example, the grill 7300 may include one container 7200 of FIG. 33 and one container 7108 of FIG. 28, three containers 7200 of FIG. 33, four containers 7108 of FIG. 28, etc.

In the example of FIG. 34, the kamado-style grill 7300 includes a cooking vessel 7310 for supporting the fire bowl 7302. The fire bowl 7302 may be positioned within the cooking vessel 7310 (as shown in FIG. 34) such that a bottom of the fire bowl 7302 rests against an interior (e.g., bottom) surface of the cooking vessel 7310. If desired, the fire bowl 7302 may be removably positioned within the cooking vessel 7310 such that the fire bowl 7302 may be placed in the cooking vessel 7310 for a period of time (e.g., during cooking, etc.), and then removed (e.g., for cleaning, etc.).

The heat source 7306 of FIG. 34 may be any suitable heat source. For example, and as shown in FIG. 34, the heat source 7306 may include a gas burner configured to direct heat into the fire bowl 7302. In such examples, the gas burner may receive a gaseous fuel such natural gas, propane, etc. In some embodiments, the heat source 7306 may be a part of a removable unit (e.g., a removable gas unit, etc.) that is insertable through an opening of the cooking vessel 7310 (e.g., an opening on a side of the cooking vessel 7310). Examples of removable units such as removable gas units including gas heat sources employable in the kamado-style grills disclosed herein are disclosed in U.S. application Ser. No. 14/920,028 filed Oct. 22, 2015, the entire disclosure of which is incorporated herein by reference. Alternatively, other suitable heat sources may be employed including, for example, a charcoal heat source, an electric heat source, etc.

Additionally, the grill 7300 may optionally include a heat spreader 7312 removably coupled to a top surface of the heat source 7306, as shown in FIG. 34. The heat spreader 7312 may be formed at least partially of a thermally conductive material to absorb heat radiated from the heat source 7306 (e.g., a gas burner, pellet burner, etc.) and spread heat away from the source 7306. Examples of heat spreaders employable in the kamado-style grills disclosed herein, e.g., in FIGS. 1-3, 10, 24-25, 30 & 32, are also disclosed in U.S. application Ser. No. 15/428,717 filed Feb. 9, 2017, the entirety of which is incorporated herein by reference.

Additionally and/or alternatively, the kamado-style grills disclosed herein (e.g., the grill 7300, etc.) may include various optional features. For example, the grill 7300 may include a lid removable and/or pivotably coupled to the cooking vessel 7310, a support frame for supporting the cooking vessel 7310, casters coupled to the support frame for moving the grill 7300, one or more ash receptacles (e.g., an ash receptacle that is part of a removable unit), one or more vents (e.g., a top vent on the lid, a bottom vent of a removable unit, etc.), one or more openings for a fire starter, etc. Examples of optional features employable in the kamado-style grills disclosed herein are disclosed in U.S. application Ser. No. 13/113,762 filed May 23, 2011 (the entire disclosure of which is incorporated herein by reference), U.S. application Ser. No. 14/920,028, and U.S. application Ser. No. 15/428,717.

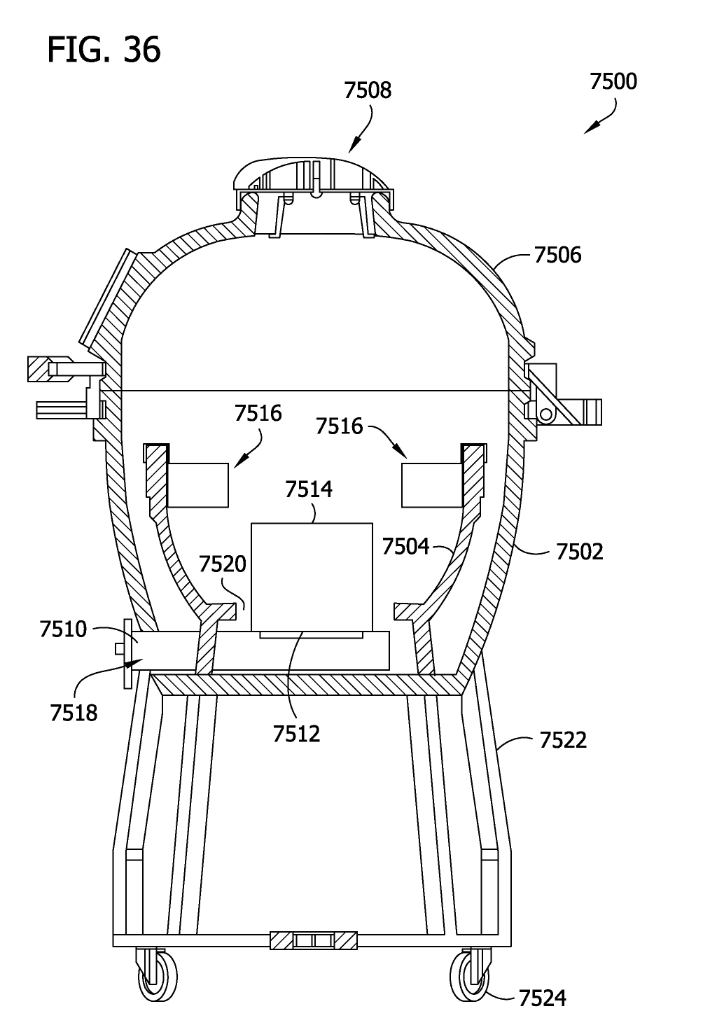

For example, FIG. 36 illustrates a kamado-style grill 7500 including a cooking vessel 7502, a fire bowl 7504 positioned in the cooking vessel 7502, a lid 7506 pivotably coupled (e.g., via one or more hinges, etc.) to the cooking vessel 7502, an upper vent 7508 adjacent a top portion of the lid 7506, a removable gas unit 7510 having a gas burner 7512, a heat spreader 7514 adjacent the gas burner 7512, and two containers 7516 removably coupled to the fire bowl 7504. The containers 7516 of FIG. 36 may be substantially similar to the containers 7200 of FIGS. 29 and 30. The heat spreader 7514 may absorb heat radiated from the gas burner 7512 and spread heat into the fire bowl 7504.

As shown, the removable gas unit 7510 is insertable through an opening 7518 in the cooking vessel 7502 such that the gas burner 7512 is positioned adjacent an opening 7520 in the fire bowl 7504. Although not shown, the removable gas unit 7510 may include one or more vents, user inputs for controlling the amount of flammable gas provided to the burner 7512, gas ports, etc.

Additionally, and as shown in FIG. 36, the grill 7500 includes a support frame 7522 for supporting the cooking vessel 7502, and casters 7524 coupled to the support frame 7522. The casters 7524 assist a user in moving the grill 7500.

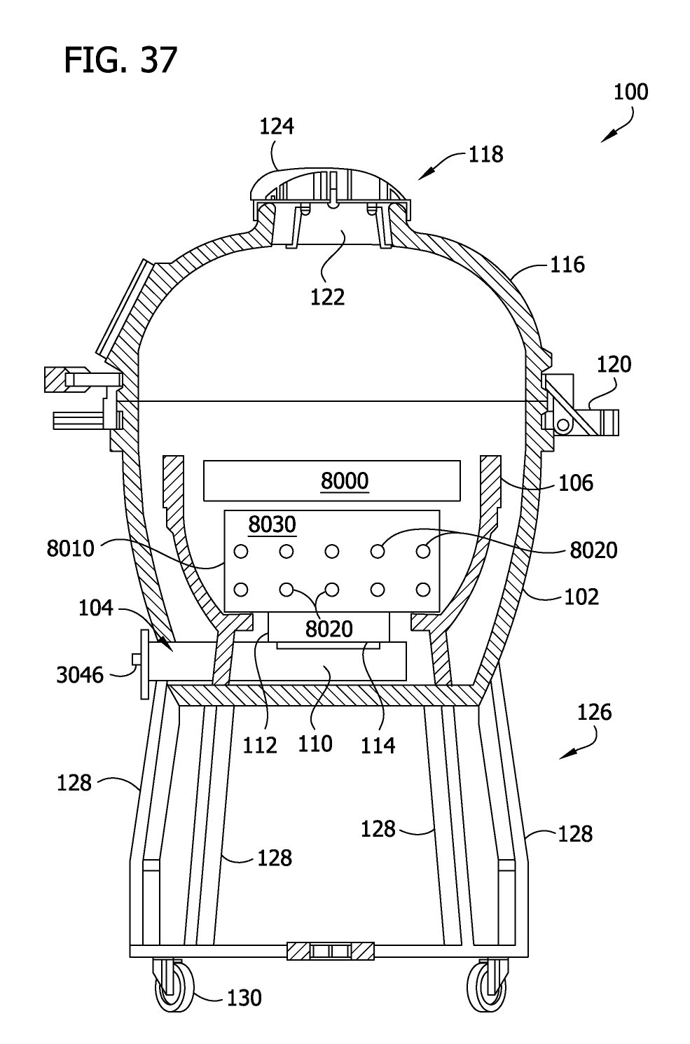

FIG. 37 shows a grill 100 as previously shown in FIG. 1, except that this grill has been set up with a container 8010 positioned around heat spreader 112. Container 8010 is resting upon a surface of the fire bowl 106 to support container 8010. Container 8010 defines a plurality of openings 8020. A water pan 8000 rests on the top of container 8010 and tends to close it off. Thus, hot air from the heat source and heat spreader 112 (whether the heat source is a gas burner or a pellet burner) tends to pass through openings in the interior wall (not seen in this view) and/or floor (also not seen in this view) and then through container 8010 and out the exterior wall 8030 of container 8010. The flavorizing material inside container 8010 is thereby heated to generate smoke or other flavor enhancer.

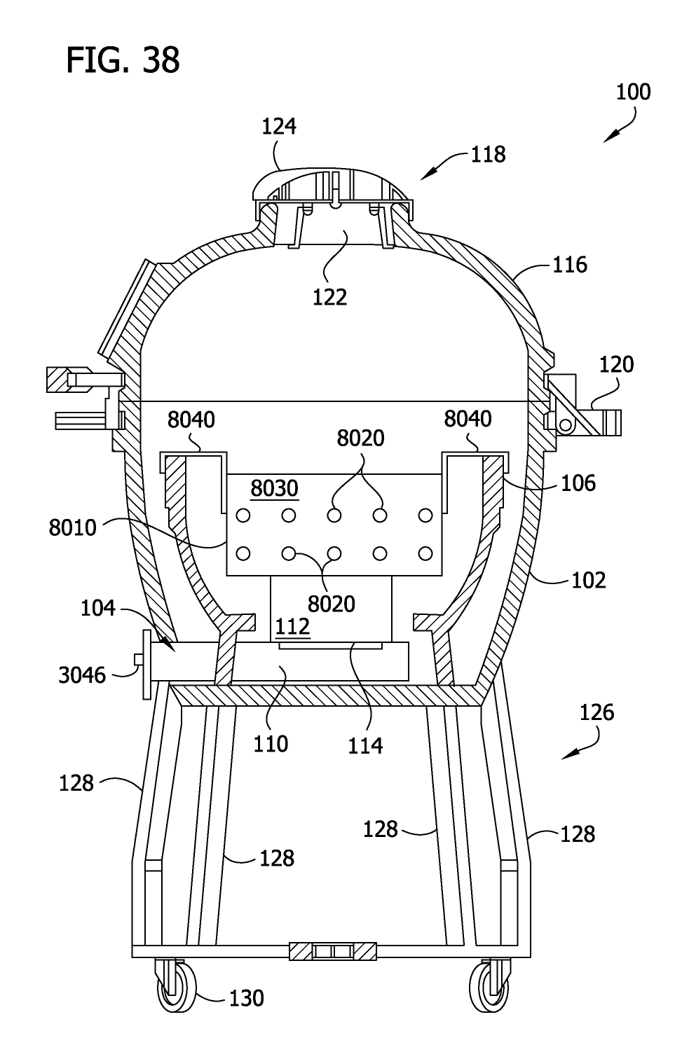

FIG. 38 shows a grill 100 as previously shown in FIG. 1, except that this grill has been set up with a container 8010 positioned around heat spreader 112. Container 8010 is suspended from the upper surface of the fire bowl 106 via support brackets 8040. Container 8010 defines a plurality of openings 8020. The top of container 8010 may be left open or closed with a lid, such as lid 8070 shown in FIG. 40, below. When lid 8070 is used to close the top, hot air from the heat source and heat spreader 112 (whether the heat source is a gas burner or a pellet burner) tends to pass through openings in the interior wall (not seen in this view) and/or floor (also not seen in this view) and then through container 8010 and out the exterior wall 8030 of container 8010. When lid 8070 is not used, hot air also passes out the top of container 8010. The flavorizing material inside container 8010 is thereby heated to generate smoke or other flavor enhancer.

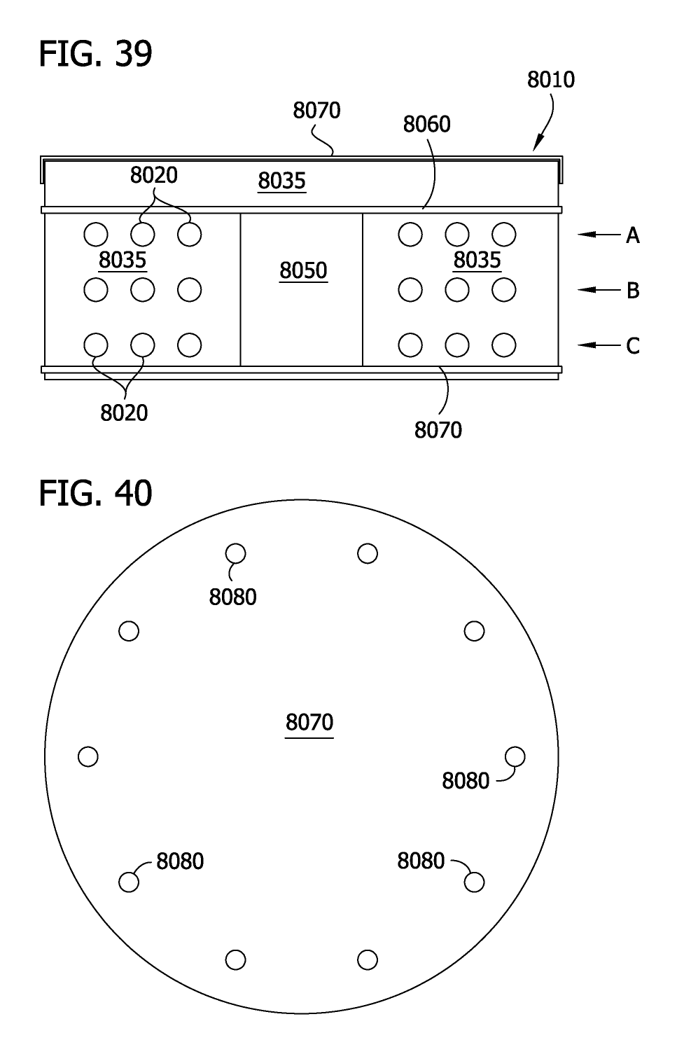

FIG. 39 shows a side view of a preferably curved sheet of metal formed as a side wall 8035. Side wall 8035 defines openings 8020. Side wall 8035 includes an upper track 8060 and a lower track 8070 that together hold a slidable cover 8050. As seen, openings 8020 are organized into horizontal rows A to C. Row A is the highest row, Row B is in the middle, and Row C is at the bottom near the floor of container 8010. As presented here, there are no openings 8020 behind cover 8050. Rather, cover 8050 can be slid to the left or right along tracks 8060/8070 to block a desired number of openings 8020. The view of side wall 8035 is a side view after it has been bent into a circle to form an interior or exterior wall of a container 8010. Additional covers 8050 (not shown) are positioned along tracks 8060/8070. The positions of the respective covers 8050 determine how many openings 8020 are blocked which thus helps control the amount of air available to the flavorizing material in the container 8010. Although three rows of openings are shown, any number or pattern of openings at any level can be used within the scope of the invention.

Any other system for selectively blocking a preferred number of openings 8020 may also be used within the scope of the invention. For example, the cover 8050 can surround a portion or the entirety of side wall 8035 between the tracks 8060/8070 and can have openings 8020 that are the same or similar to those of side wall 8035. When the cover 8050 is moved relative to side wall 8035, a portion of the openings 8020 in side wall 8035 will be obstructed to control the air flow into and out of the container 8010.

FIG. 40 shows a lid 8070 for covering container 8010. Lid 8070 may define openings 8080 to allow hot air and smoke to directly pass out of container 8010 through the lid 8070. Mechanical covers similar to covers 8050 in FIG. 39 may be employed to selectively block the openings 8080 in lid 8070.

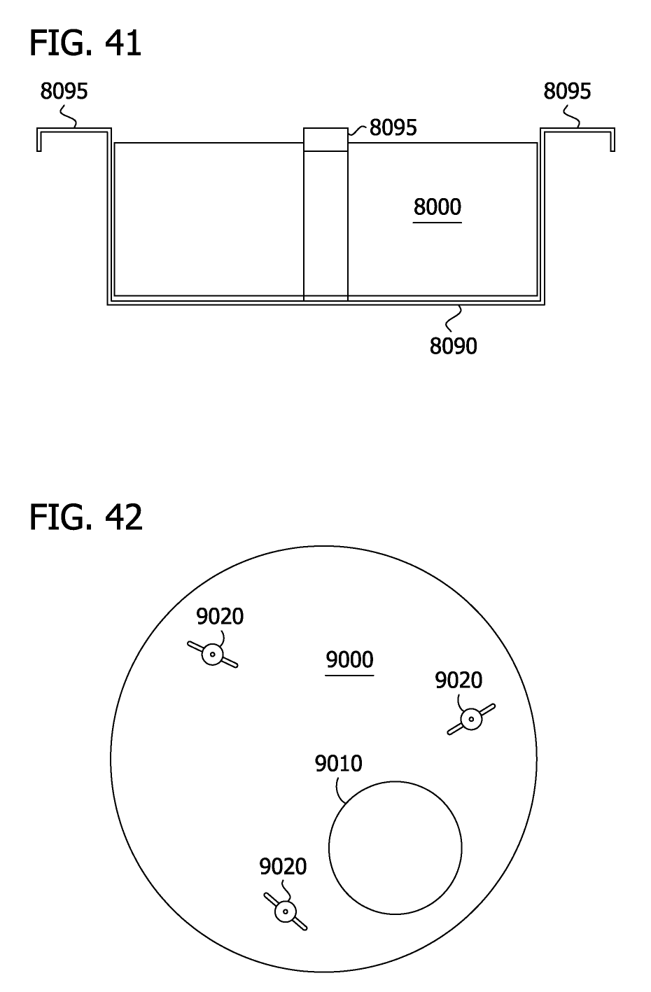

FIG. 41 shows another view of water pan 8000. In this view, water pan 8000 includes a bracket 8090 shown as a darkened line. Bracket 8090 includes arms 8095 which are adapted to rest on the upper rim of fire bowl 106 to suspend the water pan 8000 over a heat source such as heat spreader 112 and gas burner or pellet burner. Bracket 8090 may also be used to suspend water pan 8000 over a conventional charcoal or wood fire in fire bowl 106.

FIG. 42 shows a cover 9000 for covering water pan 8000. Cover 9000 defines an opening 9010 through which water may be added to the water pan 8000 during cooking. Likewise, the water level in water pan 8000 is visible through opening 9010. Cover 9000 is secured to water pan 8000 via mechanical fasteners such as wing nuts 9020 and corresponding lugs (not shown) connected to the water pan 8000. Any other releasable fastener may be used in place of wing nuts 9020 within the scope of the invention. A gasket (not shown) may be positioned between the water pan 8000 and the cover 9000 to prevent inadvertent spills when removing water pan 8000 from the grill. A handle (not shown) may also be secured to the water pan 8000 or lid 9000 to assist in moving the water pan 8000.

FIG. 43 shows a container 9030 that may hold a flavorizing liquid. Container 9030 is preferably selected in a size that fits inside a flavorizing container such as any of containers 7200, 7516 and 8010. Container 9030 may take the form of an empty soup can or the like. Container 9030 may also be specifically fabricated for use holding a flavorizing material inside a container 7200, 7516 or 8010.

It is seen, therefore, that the various containers for holding flavorizing material disclosed herein (such as those identified by reference characters 7200, 7516 and 8010) may define an opening in an interior wall, in the floor, or in the exterior wall of such container. A defined opening may be located in and near the top of the exterior wall, or may be located adjacent or below a midpoint of the exterior wall, the midpoint being a position about one half of a distance up the exterior wall measured from the floor. An opening in such a container may be in the interior wall and in the exterior wall. The container may comprise a plurality of openings in the interior wall and/or a plurality of openings in the exterior wall for allowing a hot gas from the gas burner or the pellet burner to pass into the container.

It is also seen that an adjustable cover may selectively cover one or more of the plurality of openings in the interior wall and/or the plurality of openings in the exterior wall of such a container 7200, 7516 or 8010 for controlling the burning of charcoal or wood within the container. An opening in the interior wall may be located adjacent the floor of the container.

It is also seen that a removable lid may be used to span the interior wall and the exterior wall, and the lid may define an opening for enabling smoke generated inside the container 7200, 7516 or 8010 to exit the container. A container for holding a flavorizing material may be configured as a hollow cylinder wherein the interior wall is an inner cylinder, the exterior wall is an outer cylinder, the floor is a base circle adjoining the inner and outer cylinders, and the volume of the hollow cylinder is adapted to hold the charcoal or the wood. The interior wall and the exterior wall may have a cross-sectional view that defines a pair of substantially concentric circles. A second container for holding a liquid that is sized to fit within the flavorizing container 7200, 7516 or 8010 may also be used.

The dimensions of a disclosed container 7200, 7516 or 8010 for holding a flavorizing material may also vary. A height of the exterior wall of such a container may be at least twice a width of the floor of the container. A container may be adapted to be suspended from the fire bowl in a cooking vessel or to rest on and be supported by a surface of the fire bowl. As also seen, a heat spreader may be adapted to be positioned over a gas or pellet burner and such a container 7200, 7516 or 8010 may be adapted to be positioned adjacent the heat spreader.

The grills disclosed herein are seen to optionally include a water pan 8000 adapted to be positioned above a gas burner or pellet burner and below a grate for holding food. The water pan 8000 may be adapted to be positioned above a container 7200, 7516 or 8010 that holds flavorizing material. The water pan 8000 may be adapted to be positioned to be on top of and supported by the container 7200, 7516 or 8010 to thereby cover the top of the container. The water pan 8000 may include a handle for lifting the water pan and a lid 9000 adapted to be removably fastened to the water pan. The lid 9000 may define an opening 9010 to allow the water pan to be refilled without removing the lid. The lid may have a transparent portion, whereby a water level in the pan is visible while the lid is fastened to the water pan. A bracket 8095 may be used to suspend the water pan from a fire bowl 106 inside a cooking vessel. Use of a water pan 8000 filled with water helps to keep the temperature lower in the cooking chamber when smoking meat and other food types.

The grills disclosed herein are kamado-style grills. As such, one or more components of the grills such as the fire bowls (if employed), the vessels, and/or the lids (if employed) disclosed herein may include one or more earthen materials (e.g., clay, ceramics, etc.). In some embodiments, these component(s) do not include steel or other metallic materials commonly used in conventional grills such as kettle-style grills. The containers 7200, 7516 and 8010 for holding a flavorizing material are preferably made from metal, although other materials could be used. Other optional components of the grills such as the support frames, heat spreaders, removable units, vents, etc. disclosed herein may include steel (e.g., stainless steel, etc.), plastic and/or another suitable material.

Additionally, the flavorizing material disclosed herein may include any suitable material. For example, the flavorizing material may include charcoal (e.g., lump charcoal and/or charcoal briquettes), wood (e.g., chips, chunks and/or pellets), etc. The wood may include, for example, hickory, apple, etc. The flavorizing material may also include various sized pieces. The flavorizing material may burn (e.g., provide smoke, etc.) for several hours depending on, for example, the flavorizing material used (e.g., size, type, etc.), the amount of heat applied to the flavorizing material, etc. Further, the flavorizing material may be damp. For example, wood and/or pellets may be placed in a liquid such as water before placement in a smoke tray, water may be placed in the smoke tray with the flavorizing material, etc.

Having provided this detailed description, it will be apparent that modifications and variations are possible without departing from the scope of the invention defined in the appended claims.

In view of the above, it will be seen that the several objects of the invention are achieved and other advantageous results attained.

As various changes could be made in the above systems without departing from the scope of the invention, it is intended that all matter contained in the above description and shown in the accompanying drawings shall be interpreted as illustrative and not in a limiting sense.

1. A grill assembly comprising:
a grate having an upper surface, the upper surface configured to support an item of food to be cooked;
a cooking chamber;
a gas burner or a pellet burner, the gas burner or pellet burner being adapted to be installed within the cooking chamber and below the grate and to operate using a gaseous fuel or a pellet fuel; and
a container comprising an interior wall, a floor, and an exterior wall;
wherein the container is adapted to be positioned within the chamber, below the grate, and with the interior wall adjacent the gas burner or the pellet burner;
wherein at least one of the interior wall, the floor and the exterior wall of the container defines an opening for allowing a hot gas from the gas or pellet burner to pass into the container; and
wherein the container is adapted to hold charcoal and/or wood.

2.-11. (canceled)

12. The grill assembly of claim 1, wherein the container comprises a plurality of openings in the interior wall and/or a plurality of openings in the exterior wall for allowing a hot gas from the gas burner or the pellet burner to pass into the container.

13. The grill assembly of claim 12, further comprising an adjustable cover to selectively cover one or more of the plurality of openings in the interior wall and/or the plurality of openings in the exterior wall for controlling burning of the charcoal or wood within the container.

14. (canceled)

15. The grill assembly of claim 1, wherein the container further comprises a removable lid spanning the interior wall and the exterior wall.

16.-41. (canceled)

42. A container adapted to be used with a grill assembly, the grill assembly comprising: a grate having an upper surface, the upper surface configured to support an item of food to be cooked; a cooking chamber; and a gas burner or a pellet burner, the gas burner or pellet burner being adapted to be installed within the cooking chamber and below the grate and to operate using a gaseous fuel or a pellet fuel; the container comprising:
an interior wall, a floor, and an exterior wall;
wherein the container is adapted to be positioned within the chamber, below the grate, and with the interior wall adjacent the gas burner or the pellet burner;
wherein at least one of the interior wall, the floor and the exterior wall of the container defines an opening for allowing a hot gas from the gas or pellet burner to pass into the container; and
wherein the container is configured to hold charcoal and/or wood.

43. The container of claim 42, wherein the opening in the container further comprises: an opening in the interior wall, an opening in the floor, an opening in the exterior wall, or a combination thereof.

44.-45. (canceled)

46. The container of claim 42, wherein: the opening in the exterior wall is located near the top of the exterior wall; or the opening in the exterior wall is located adjacent or below a midpoint of the exterior wall, the midpoint being a position about one half of a distance up the exterior wall measured from the floor.

47.-48. (canceled)

49. The container of claim 42, wherein the container comprises a plurality of openings in the interior wall and/or a plurality of openings in the exterior wall for allowing a hot gas from the gas burner or the pellet burner to pass into the container.

50. The container of claim 49, further comprising an adjustable cover to selectively cover one or more of the plurality of openings in the interior wall and/or the plurality of openings in the exterior wall for controlling burning of the charcoal or wood within the container.

51. (canceled)

52. The container of claim 42, wherein the container further comprises a removable lid spanning the interior wall and the exterior wall.

53. The container of claim 52, wherein the lid defines an opening for enabling smoke generated inside the container to exit the container.

54. The container of claim 52, wherein the container has an arcuate shape; or the container is configured as a hollow cylinder, and wherein the interior wall is an inner cylinder, the exterior wall is an outer cylinder, the floor is a base circle adjoining the inner and outer cylinders, and the volume of the hollow cylinder is adapted to hold the charcoal or the wood; or the interior wall and the exterior wall have a cross-sectional view that defines a pair of substantially concentric circles.

55.-57. (canceled)

58. The container of claim 42, further comprising a water pan.

59. The container of claim 58, wherein the water pan is adapted to be positioned above the container.

60. The container of claim 59, wherein the water pan is further adapted to be positioned on top of and supported by the container; and wherein the water pan is thereby adapted to cover the top of the container.

61. The container of claim 42, further comprising a second container sized to fit within the container, the second container adapted to hold a liquid.

62. The container of claim 58, wherein the water pan further comprises a lid adapted to be removably fastened to the water pan.

63. The container of claim 62, wherein the lid defines an opening to allow the water pan to be refilled without removing the lid; or the lid comprises a transparent portion, whereby a water level in the pan is visible while the lid is fastened to the water pan.

64. (canceled)

65. The container of claim 58, further comprising a handle for lifting the water pan; or further comprising a bracket for suspending the water pan from a fire bowl inside the cooking chamber.

66. (canceled)

67. The container of claim 42, wherein the container comprises metal or an earthen material.

68.-76. (canceled)
